(19) United States
(12) Patent Application Publication
(10) Pub. No.: US 2026/0239170 A1
(43) Pub. Date: Aug. 13, 2026

(54) CROSS-DOMAIN TRUST EVALUATION IN WIRELESS SYSTEMS

(71) Applicant: InterDigital Patent Holdings, Inc., Wilmington, DE (US)

(72) Inventors: Liangkun Yu, Conshohocken, PA (US); Chonggang Wang, Princeton, NJ (US); Robert Gazda, Spring City, PA (US); Xu Li, Plainsboro, NJ (US); Samir Ferdi, Kirkland (CA); Ulises Olvera-Hernandez, Saint-Lazare (CA); Rocco Di Girolamo, Laval (CA); Michael Starsinic, Newtown, PA (US); Michel Roy, Candiac (CA); Catalina Mladin, Hatboro, PA (US)

(73) Assignee: InterDigital Patent Holdings, Inc., Wilmington, DE (US)

(21) Appl. No.: 19/049,711

(22) Filed: Feb. 10, 2025

(51) Int. Cl. H04W 48/08; H04W 8/22; H04W 12/08

(52) U.S. Cl. CPC H04W 48/08; H04W 8/22; H04W 12/08

(57) ABSTRACT

A wireless transmit/receive unit (WTRU) is configured to: receive trust management function (TMF) configuration information comprising at least one identifier of at least one external TMF (eTMF); send a first request message to a first network node comprising a first service identification; receive a second request message from a second network node comprising an identifier of the second network node and a second service identification; determine that the identifier of the second network node matches an identifier from the at least one identifier of the at least one eTMF; determine that the second service identification matches the first service identification; send a first response message to the second network node indicating permission for the second network node to expose WTRU trust information to a third network node; receive a second response message from the first network node that indicates whether the requested service in the first request message is granted.

### BACKGROUND

A fifth Generation (5G) system architecture comprises a User Equipment (UE) or a wireless transmit/receive unit (WTRU), a Radio Access Network (RAN), and a Core Network. A design principle for the 5G System (5GS) is service-centric or service-based. A 5G Core Network (5GC) follows Service-Based Architecture (SBA) and comprises a variety of Network Functions (NFs), which work together to fulfill and provide needed services to the RAN, WTRUs, and Application Servers/Service Providers. A WTRU interacts with the RAN/5GC via Non-Access Stratum (NAS) and Access Stratum signaling.

### SUMMARY

A method for use by a wireless transmit/receive unit (WTRU) may comprise receiving trust management function (TMF) configuration information that comprises at least one identifier of at least one external TMF (eTMF). The at least one eTMF may be a TMF that operates in a different network domain as the WTRU. The method may comprise sending a first request message to a first network node. The first request message may comprise a first service identification (service ID) that indicates a requested service. The method may comprise receiving a second request message from a second network node. The second request message may comprise an identifier of the second network node, and a second service ID. The method may comprise determining that the identifier of the second network node in the second request message matches an identifier from the at least one identifier of the at least one eTMF in the TMF configuration information. The method may comprise determining that the second service ID in the second request message matches the first service ID in the first request message. The method may comprise sending a first response message to the second network node that indicates permission for the second network node to expose WTRU trust information to a third network node. The method may comprise receiving a second response message from the first network node that indicates whether the requested service in the first request message is granted. The first request message may be a network function (NF) access request message. The first network node may be a network function producer (NFP). The TMF configuration information may further comprise an identifier of an internal TMF (iTMF). The iTMF may be a TMF that operates in a same network domain as the WTRU. The first request message may be sent using non-access stratum (NAS) signaling or a service-based interface (SBI). The first request message may comprise at least one of: an internal WTRU identifier for a domain that the WTRU is operating in, an external WTRU identifier for a domain that the WTRU is not operating in, a WTRU credential, a WTRU context, an indication of a set of mapping pairs between the at least one identifier of the at least one eTMF and the external WTRU ID, an indication of a WTRU hardware parameter, and an indication of a WTRU power source. The second request message may be a trust exposure request message that is a request for permission to share the WTRU's trust information with an internal TMF (iTMF). The iTMF may be a TMF that operates in a same network domain as the WTRU. The second request message may comprise an identifier of the third network node. The method may comprise determining that the identifier of the third network node in the second request message matches an identifier of an iTMF received in the TMF configuration information. The second network node may be an eTMF. The third network node may be an internal TMF (iTMF). The first response message may comprise at least one of: an indication of a number of external trust information requests that the second network node is allowed to expose the WTRU trust information; an indication of a time period for which WTRU trust permission is valid; and a list of iTMFs which the WTRU approves the eTMF to expose WTRU trust information without WTRU permission. The second response message may comprise a failed reason in response to the requested service being denied.

A wireless transmit/receive unit (WTRU) may comprise a transmitter, a receiver, and a processor. The receiver may be configured to receive trust management function (TMF) configuration information that comprises at least one identifier of at least one external TMF (eTMF). The at least one eTMF may be a TMF that operates in a different network domain as the WTRU. The transmitter may be configured to send a first request message to a first network node. The first request message may comprise a first service identification (service ID) that indicates a requested service. The receiver may be further configured to receive a second request message from a second network node. The second request message may comprise an identifier of the second network node, and a second service ID. The processor may be configured to determine that the identifier of the second network node in the second request message matches an identifier from the at least one identifier of the at least one eTMF in the TMF configuration information. The processor may be further configured to determine that the second service ID in the second request message matches the first service ID in the first request message. The transmitter may be further configured to send a first response message to the second network node that indicates permission for the second network node to expose WTRU trust information to a third network node. The receiver may be further configured to receive a second response message from the first network node that indicates whether the requested service in the first request message is granted. The first request message may be a network function (NF) access request message. The first network node may be a network function producer (NFP). The TMF configuration information may further comprise an identifier of an internal TMF (iTMF). The iTMF may be a TMF that operates in a same network domain as the WTRU. The first request message may be sent using non-access stratum (NAS) signaling or a service-based interface (SBI). The first request message may comprise at least one of: an internal WTRU identifier for a domain that the WTRU is operating in, an external WTRU identifier for a domain that the WTRU is not operating in, a WTRU credential, a WTRU context, an indication of a set of mapping pairs between the at least one identifier of the at least one eTMF and the external WTRU ID, an indication of a WTRU hardware parameter, and an indication of a WTRU power source. The second request message may be a trust exposure request message that is a request for permission to share the WTRU's trust information with an internal TMF (iTMF). The iTMF may be a TMF that operates in a same domain as the WTRU. The second request message may comprise an identifier of the third network node. The processor may be further configured to determine that the identifier of the third network node in the second request message matches an identifier of an iTMF received in the TMF configuration information. The second network node may be an eTMF. The third network node may be an internal TMF (iTMF). The first response message may comprise at least one of: an indication of a number of external trust information requests that the second network node is allowed to expose the WTRU trust information; an indication of a time period for which WTRU trust permission is valid; and a list of iTMFs which the WTRU approves the eTMF to expose WTRU trust information without WTRU permission. The second response message may comprise a failed reason in response to the requested service being denied.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example cross-domain interaction scenario;

FIG. 3 shows a service flow example of a cross-domain interaction scenario;

FIG. 4 shows an example procedure of service interaction enabled with cross-domain collaborative trust evaluation;

FIG. 5 shows a trust indicator chart for maximizing over each indicator in trust indicator (TIDC) sets before aggregating to generate a trust index (TIDX);

FIG. 6 shows an example of indirect final TIDX calculation via TIDC calculation;

FIG. 7 shows an example of direct final TIDX calculation;

FIG. 8 shows an example procedure where an internal Trust Management Function (iTMF) pulls additional trust information from external Trust Management Functions (eTMFs);

FIG. 9 shows an example procedure where a WTRU request an eTMF to provide trust information to an iTMF; and

FIG. 10 shows an example procedure where a WTRU provides trust information to an eTMF.

### DETAILED DESCRIPTION

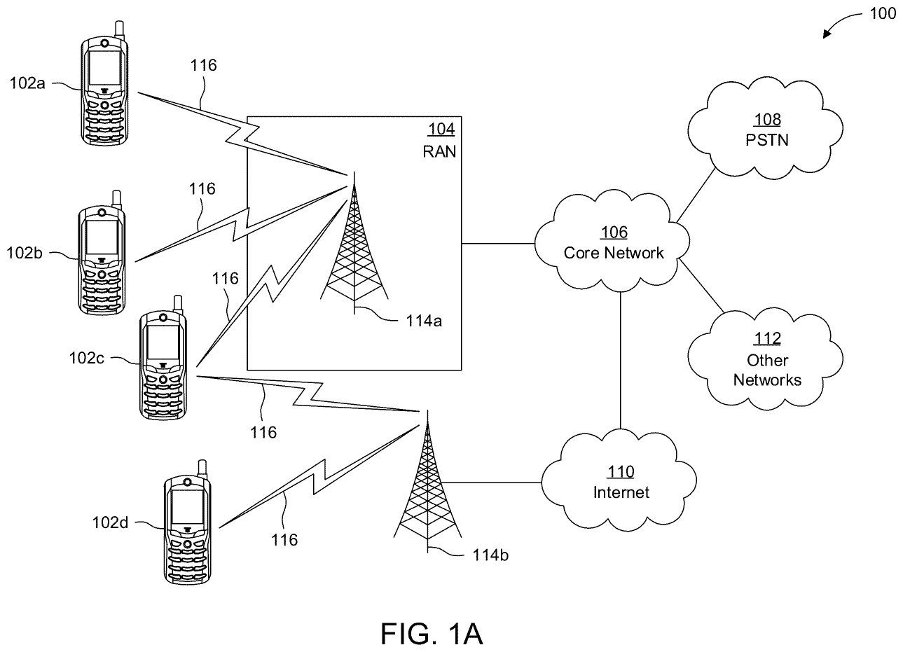

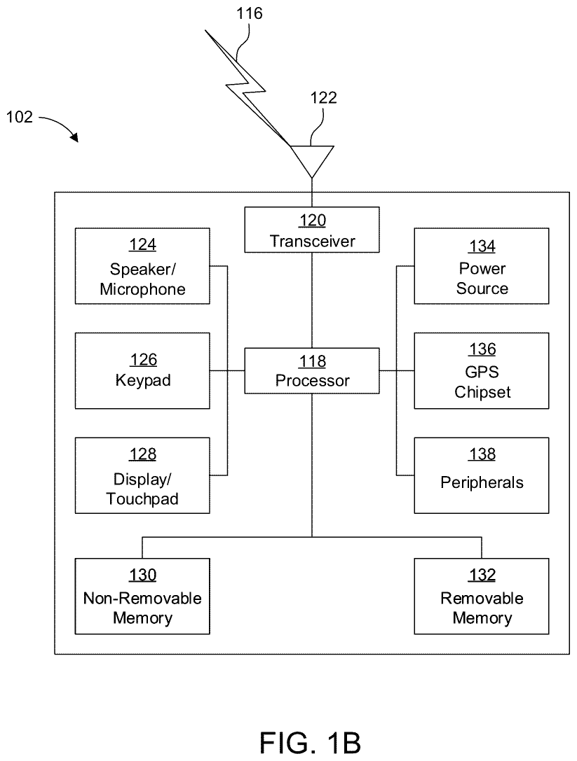

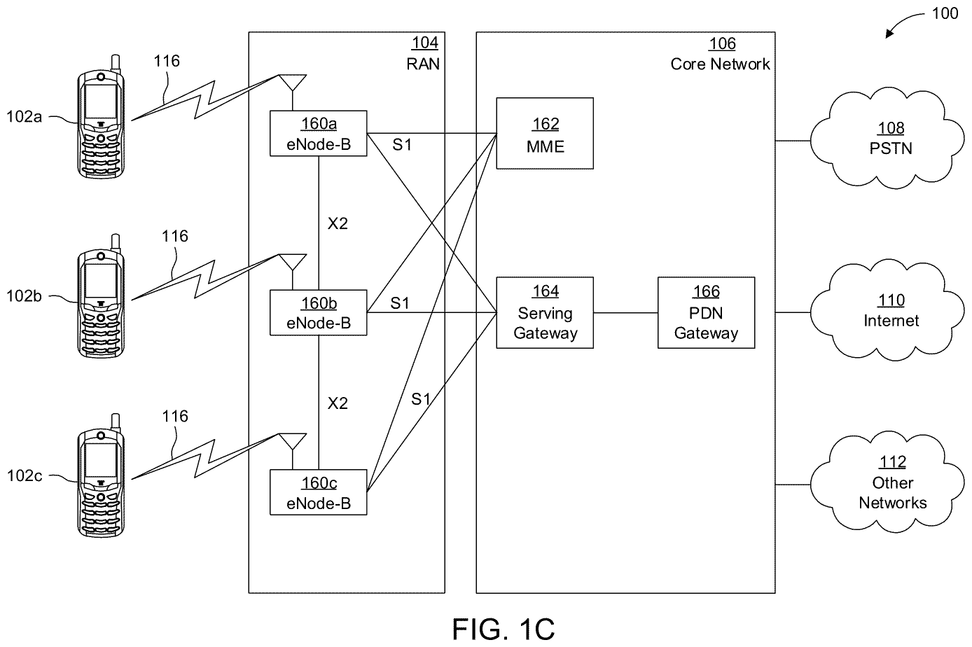

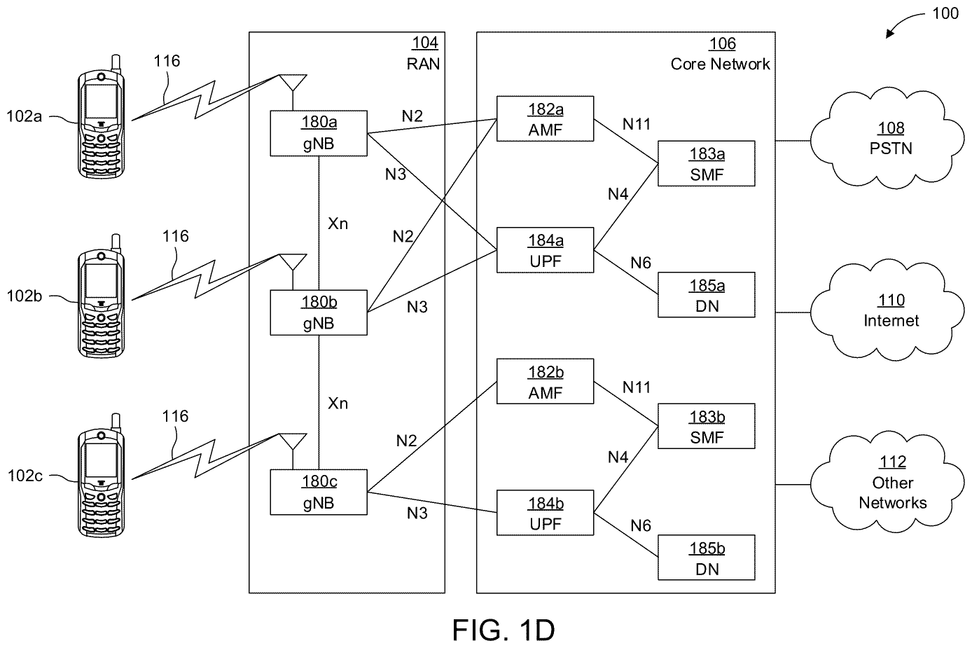

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80 +80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An NF may access other network functions in a request/response mode or a subscription/notification mode. Before two NFs interact with each other, they first need to register with a Network Repository Function (NRF) so that they can discover each other via the NRF. Among these network functions, an Access and Mobility Management Function (AMF) is dedicated to managing WTRU's access to the 5GS and its mobility, a Session Management Function (SMF) is responsible for establishing sessions between a WTRU and the 5GC, and an Authentication Server Function (AUSF) takes charge of WTRU authentication. In addition, a Policy Control Function (PCF) provides policy rules for other control plane network functions and WTRUs. The PCF assigns an identifier for each created policy rule, which other control plane network functions and WTRUs use to refer to the corresponding policy rule. A User Plane Function (UPF) is the only core network function in the data plane that facilitates monitoring, managing, controlling, and redirecting user plane traffic flows such as between a WTRU and an Application Function (AF). A Network Exposure Function (NEF) enables access to 5G control plane functions to entities such as network applications and AFs which are outside of the 5GS and not in the same trusted domain.

Two NFs (one as a service consumer and the other as a service producer) may communicate with each other directly without any entity in the middle or indirectly via a Service Communication Proxy (SCP). An SCP is responsible for forwarding and routing messages between an NF service consumer and an NF service producer. In addition, two NFs may interact with each other using a Request/Response model or a Subscribe/Notify model. In a Request/Response model, an NF service consumer sends a request to an NF service producer. The NF service producer processes the request and sends a response to the NF service consumer. In a Subscribe/Notify model, an NF service consumer first sends a subscription request to an NF service producer. The NF service producer processes the subscription request and stores the subscription information. Whenever any subscribed event occurs, the NF service producer sends a notification to the NF service consumer.

A 5GC also provides data storage and analytics services through functions such as a Unified Data Management (UDM), a Unified Data Repository (UDR), an Unstructured Data Storage Function (UDSF) and a Network Data Analytics Function (NWDAF). Another critical feature of the 5GS is network slicing, which is facilitated by a Network Slice Selection Function (NSSF).

A 5GS introduces a few network functions such as a Location Management Function (LMF) to support location services. An LMF is responsible for calculating, determining, or verifying a final location and any velocity estimation and may estimate the achieved accuracy, based on location information from the subject WTRU and/or a RAN node. After the LMF calculates the location of a subject WTRU, other entities may access or query its location from the LMF but need to go through a serving AMF.

Although these network functions are defined as separate logical entities, a particular service scenario may require multiple network functions, for instance, WTRU mobility will need not only an AMF, but also an AUSF and an SMF. For a type of network function, multiple instances may be instantiated and an NRF will maintain the information of each instantiated network function instance. With the emergence of edge computing, some network functions in 5GC such as a UPF and an NEF may be deployed and resided in an edge network that is much nearer to and potentially co-located with the RAN.

Existing cellular wireless systems (e.g., 5GS) provide various security functions such as primary authentication during registration, secondary authentication during Protocol Data Unit (PDU) session establishment, NF service authorization, network slicing-specific authentication and authorization, network slicing admission control, and data plane encryption and integrity protection.

NF service authorization in 5GS may be static authorization or token-based authorization. In static authorization, some local authorization policies are maintained at an NRF and NF service producer. Those local authorization policies are used to authorize a NF service consumer, when the NF service consumer discovers NF service producers from the NRF or when it requests to access services from a discovered NF service producer. In token-based authorization, an NRF may grant an access token to a NF service consumer. Then, the NF service consumer presents the access token to the NF service producer, which will authorize the NF service consumer based on the access token.

Trust refers to a measurable belief that represents an accumulated value (e.g. about the quality/behavior/performance/characteristic of a network node, a WTRU, a service or any logical/physical entity) from history and an expected value for the future. Trust may be objective trust or subjective trust. The objective trust leverages a security mechanism, such as authentication, to validate an entity's identity. However, trust covers and is beyond security. For example, an entity passing the authentication only means the entity has successfully proved its identity, but it still may not be fully trusted since the trust about the entity's behavior/characteristics may still be dynamically changing and the criteria for evaluating trust may also be subjective (e.g. based on user/personal experience/preference). Trust is an essential input for decision making and it is usually measured or calculated based on the history experience/records in the past, and it represents the expected value of quality, behavior, characteristics, and/or performance in the future.

A trust index may be obtained via a trust evaluation process. A trust index may be used to describe the trust of an entity. The trust index is an overall metric, which is often calculated based on the aggregation of one or more trust indicators (depending on the user's subjective trust evaluation criteria) using certain trust evaluation algorithms. The trust indicators may cover various aspects, such as security, privacy, resilience, performance, robustness, scalability, availability, accuracy, reliability, and consistency. During a trust evaluation process, various data about an entity may be collected and those data may be used as inputs to calculate various trust indicators, which in turn are aggregated into an overall metric (i.e. the current trust index of the entity). Trust has various characteristics. For example, trust is dynamic, meaning that a given trust index may be applicable for a limited time period and may change as time goes on. Trust is also context-dependent, which means that the trust may have a significant change if the context gets changed or changes. Trust is not transitive in nature, but trust may be transitive in some particular contexts. Similarly, trust is an asymmetric relationship, meaning that a fact of entity A trusting entity B cannot deduce that entity B also trusts entity A. In addition, trust may also be subjective, which means for the same entity, different users may have different criteria/opinions/preferences regarding how to evaluate the trust of this entity and what kinds of trust-related aspects/indicators shall be considered.

Trust generation, trust evaluation, trust assessment, trust measurement, trust computation and trust calculation may be used interchangeably in this disclosure unless there is an explicit clarification. Trust index generation, trust index evaluation, trust index assessment, trust index measurement, trust index computation and trust index calculation may be used interchangeably in this disclosure unless there is an explicit clarification.

In future wireless systems, each device serves as a convergence point for both communication and computation. A user may access services from a network function or an external application function and, simultaneously, provide services to these entities. These services may include but not limited to NWDAF, AI as a Service (AaaS), Computation as a Service (CaaS), and Sensing as a Service (SaaS).

Dynamic user behaviors, such as moving from one Public Land Mobile Network (PLMN) or non-Public Network (NPN) to another, along with diverse inter-domain service combinations (e.g. sharing data with an external AF or offloading AI tasks via an external AI broker AF) create a clear need for enhanced trustworthiness. In such scenarios, trust metrics collected in one domain must be shared with other domains to collectively determine the overall trustworthiness.

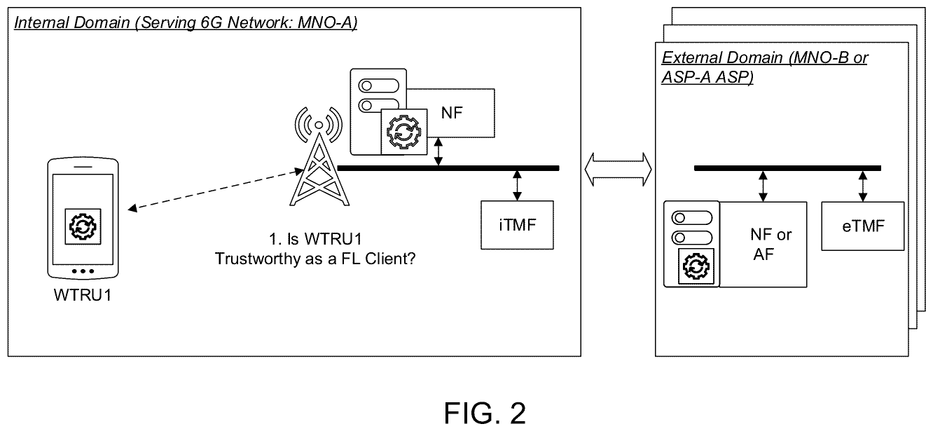

A cross-domain interaction scenario is shown in FIG. 2. WTRU1 initiates new activity with or roams to the current sixth Generation (6G) network (e.g., mobile network operator (MNO)-A), which may be regarded as an internal domain. Specifically, WTRU1 registers itself to MNO-A as a federated learning (FL) client. MNO-A needs to evaluate the trustworthiness of WTRU1 and determine if WTRU1 may be registered as a FL client. However, MNO-A does not have sufficient historical data about WTRU1 as a FL client. In the meantime, WTRU1 may have interacted with its home network (e.g., MNO-B, if WTRU1 is in roaming) and/or an FL-oriented application service provider (e.g., application service provider (ASP)-A) as a FL client. Thus, MNO-A may request FL-related historical data and corresponding trust information from MNO-B and/or ASP-A, which are regarded as an external domain from MNO-A's perspective.

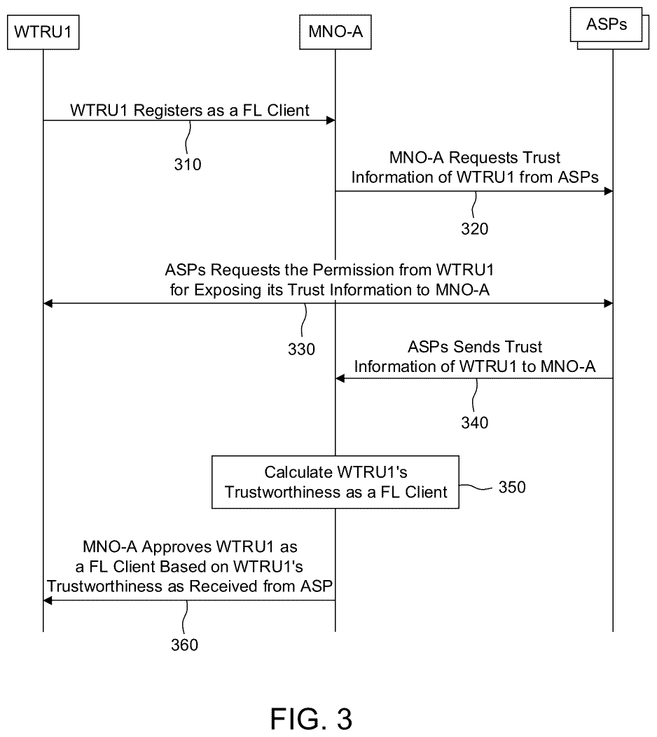

A service flow example for the cross-domain scenario is shown in FIG. 3, where an external domain provides trust information about a WTRU to an internal domain. WTRU1 may register itself as an FL client with MNO-A 310. MNO-A cannot determine the trustworthiness for WTRU1 as an FL client. For example, the honesty of an FL client cannot be assessed without long-term interaction to detect potential malicious behavior, such as injecting random gradients with malicious intent. MNO-A may contact (send a request message to) ASP-A for trust assistance regarding WTRU1 320. If necessary, MNO-A may reach out to different ASPs to gather information not available within MNO-A. ASP-A may request the permission from WTRU1 for exposing its trust information to MNO-A 330. With the permission from WTRU1, ASP-A may review the history of WTRU1 as an FL client and may send trust information of WTRU1 to MNO-A 340. MNO-A may evaluate the trust information from different ASPs and calculate the trustworthiness of WTRU1 as an FL client 350. Based on the trustworthiness of WTRU1 as an FL client, MNO-A may decide whether to approve WTRU1 as an FL client or not and may send the decision to WTRU1 360.

When a WTRU initiates new activities in a current wireless network (e.g., either a home or a visited 6G network), an internal Trust Management Function (iTMF), which operates within the current wireless network serving the WTRU, may encounter difficulties in evaluating the trustworthiness of the WTRU due to the lack of prior interaction history. For example, if the WTRU attempts to register to the current wireless network as a federated learning (FL) client, especially for the first time, the iTMF may be unable to determine whether the WTRU is a legitimate FL participant or a malicious one, as there is insufficient historical data that the iTMF may leverage to make an informed decision on the trustworthiness of the WTRU from a FL perspective. In this scenario, external TMFs (eTMFs) may be used to provide additional trust information.

When two Function Entities (FEs) interact with each other, there is a need to determine how can they leverage iTMFs and eTMFs to retrieve a complete and confident trust information of each other to augment their mutual trust and in turn realize trustworthy service interactions among FEs.

A Function Entity (FE) is a processing function, such as network functions specified in 3GPP TS 23.501, and may be represented by an FE in this disclosure. This FE may also serve as an AF, an edge application or service, a device-provided service, a device-hosted application, or a server or service within a data network, among other possibilities.

An FE Service Consumer (FESC) is an FE that accesses services provided by FE service producers (e.g., NF service producer as defined in 3GPP TS 23.501). An FE service consumer may be a NF service consumer as defined in 3GPP TS 23.501, an AF, an edge application or service, a device-hosted application, or a server within a data network. A device may be a FESC. A single device may have multiple FESCs.

An FE Service Producer (FESP) is an FE that provides services to FE service consumers. A FE service producer may be a NF service producer as defined in 3GPP TS 23.501, an AF, an edge application or service, a service enabler, or a service on another device. A device may be a FESP. A single device may have multiple FESPs.

A Trust Management Function (TMF) is an FE that may assess and calculate the trust index for other entities including but not limited to a device, a user, an AF, a NF, a service, and an application. The TMF may assess and calculate the trust index of FESCs and FESPs. The TMF may also expose the calculated trust index to other FEs within the same domain. When sharing trust-related information with other TMFs across domains, the TMF may require permission from the subject entity (i.e., a FE).

A domain refers to a self-governing operational environment with control over its internal resources, services, and policies. Examples of domains include but are not limited to a PLMN (e.g., a public network), a NPN (e.g., a non-public network), a cloud service provider, an application service provider, an AI service provider, an internet service provider, or a social media platform. Cross-domain interactions occur when two or more domains collaborate or exchange information, such as PLMN-to-PLMN interactions or communications between a PLMN and an Application Function (AF) with a Data Network (DN).

The terms internal TMF (iTMF) and external TMF (eTMF) are defined relative to the domain in which a WTRU is currently connected. The iTMF operates within the current PLMN or NPN that the WTRU is currently connected to and manage trust evaluations and service access decisions for that domain. In contrast, the eTMF resides outside the current PLMN and may belong to another domain such as but not limited to another PLMN, a cloud service provider, an application service provider, an AI service provider, an internet service provider, or a social media platform. The iTMF may actively/passively collaborate with other eTMFs to obtain additional trust information and/or historical data about the WTRU's trustworthiness.

An identifier is the name/identifier/address of an entity (e.g., a user, a device, a FE, an entity using a device, etc.). An identifier may be a 3GPP identifier, an IP address, a URL (Uniform Resource Locator), a FQDN (Fully Qualified Domain Name), a blockchain address, or distributed user identifier. The identifier of an entity enables or gives access details based on which other entities may access and interact with this entity.

A Trust Index (TIDX) is a quantitative measure representing the trust level or trustworthiness of an FE within a specified range or scale. A TIDX is generated by a TMF as the result of its trust evaluation. During this process, a confidence value is also determined or computed, which reflects the certainty or reliability of the trust assessment. However, this confidence value may not be shared with FEs. FEs may utilize the TIDX to determine their level of service accessibility or eligibility to interact with other FEs.

A Trust Indicator (TIDC) is a set of trust metrics or key performance indicators (KPIs) that provide a multi-faceted assessment of trust. These indicators evaluate the performance of an FE from various perspectives, such as throughput, latency, scalability, and other operational metrics. Unlike TIDX, which provides an overall trust score based on a set of TIDC, the TIDC focuses on specific and measurable performance dimensions that contribute to the overall trust evaluation. The exact KPIs included in the TIDC are service-dependent, meaning they vary according to the specific requirements and characteristics of the service being accessed, requested or provided.

A Trust Information (TINFO) is a general term representing trust-related data associated with an FE. It serves as an overarching concept that may refer to a TIDX, a TIDC and/or any trust-related information, depending on the specific service context.

A Trusted Party (TP) is a trusted intermediary that is mutually trusted by two different parties. Its role is to bridge the trust gap between the two parties by transferring the trust of one party to the other.

A Service ID (ServiceID) is an identifier, name, or type of the target service and/or the specific service operation involved in trust index calculations, where a trust index may be calculated per ServiceID for a FESC or a FESP. Different service operations within the same service may be each assigned a unique ServiceID. These service operations may include but are not limited to service discovery, service initialization, service access, service information retrieval, service offloading, service adjustment, service subscription management, and service cancellation.

A Wireless Network may be, for example, a PLMN, an NPN, a WiFi network, a Customer Premises Network (CPN), a Personal IoT Network (PIN), a Vehicular-to-Everything (V2X) network, a connected robot network, or an Aircraft-to-Everything (A2X) network. A wireless network serving an FE is referred to as a serving wireless network, which may be a visited wireless network or a home wireless network. A wireless network may be a 5GS or a 6GS. A wireless network may be a part of 5GS or 5GS.

To expose trust information of a subject FE (e.g., WTRUs, users, applications, or services) from an eTMF to an iTMF should inform and be approved by the subject FE. Potential benefits of doing this include: 1) controllability by the subject FE; and 2) privacy protection for the subject FE.

Trust collaboration establishment between an iTMF and an eTMF could be a prerequisite before exposing trust information of a subject FE between them. Potential benefits of doing this include: 1) secure trust information exposure; 2) exposed trust information can be trusted.

Trust information exposure should be flexible and should not be limited to or controlled by a single entity (e.g., iTMF, eTMF, or the subject FE). In other words, either an iTMF, an eTMF and/or the subject FE should be able to initiate or trigger trust information exposure from an eTMF to an iTMF. Potential benefits of doing this include: 1) flexible trust information exposure; and 2) avoiding a single point of failure.

If information elements or parameters can be preconfigured or previsioned, they may not need to be transmitted over the interface between two FEs. Potential benefits of doing this include: 1) reduced communication overhead; 2) reduced information leakage and improved security; and 3) reduced communication message processing overhead.

Trustworthy service interaction may be enabled by cross-domain collaborative trust evaluation. In an embodiment, when FEs interact with each other for providing and consuming services (e.g., FE1 providing services to FE0 or vice versa), an FE (FE1) may contact an iTMF (internal Trust Management Function) to obtain the trust index (TIDX) of another FE (FE0) for purposes such as trust-based authentication, service admission control, service allocation, and service invocation. If the iTMF cannot generate a TIDX based on its local monitoring and/or information it may obtain within the internal domain, it may send an external TINFO (trust information) request to a list of trusted eTMFs (external Trust Management Functions) which are associated with FE0's profile and may provide additional TINFO about FE0. Upon receiving an external trust information request from the iTMF, an eTMF may seek permission/consent from FE0 to expose TINFO (trust information) to the iTMF. Once receiving permission/consent from FE0, the eTMF may send the requested TINFO to the iTMF, which may then calculate or determine the trust index of FE0 incorporating the received TINFO. The iTMF may then deliver the trust index to FE1.

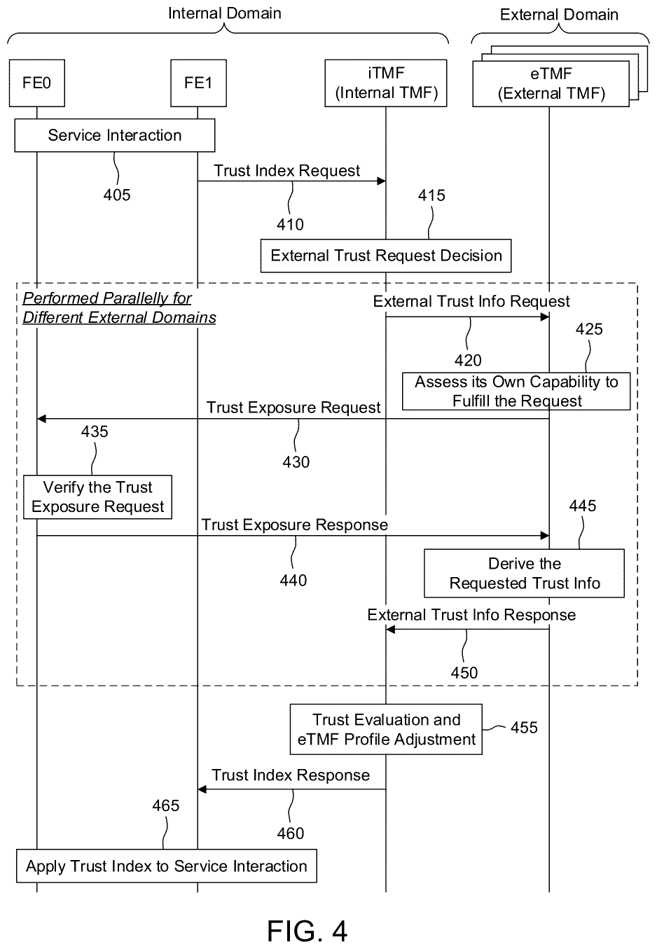

FIG. 4 shows an example procedure of trustworthy service interaction between two FEs enabled by cross-domain collaborative trust evaluation, where eTMFs provide additional trust information of FEs to the iTMF for more complete and accurate trust evaluation for the FEs.

The service interactions among the two entities, FE0 and FE1, may occur with one FE as a service consumer and the other FE as a service producer 405. The service interactions between the FEs may be a service discovery where, FE1 (or FE0) acts as a repository function, while FE0 (or FE1) seeks to discover a suitable service producer from the repository function FE1. The TIDX of FE0 (or FE1) aids the repository function FE1 (or FE0) in identifying the most appropriate service producer for FE0 (or FE1). In addition, FE0 and FE1 may need to retrieve each other's TIDX from the iTMF for them to perform mutual trust with each other based on the TIDX. The service interactions between the FEs may be a service access, where FE0 (or FE1) requests to access a service provided by FE1 (or FE0). In this case, FE1 (or FE0) may need to retrieve the TIDX of FE0 (or FE1) from the iTMF to determine the trust level of FE0 (or FE1) and the corresponding services that FE0 (or FE1) may access. In addition, FE0 and FE1 may need to retrieve each other's TIDX from the iTMF for them to perform mutual trust with each other based on the TIDX.

The service producer FE (e.g., FE1) may retrieve a TIDX of service consumer FE (e.g., FE0) to determine subsequent service accessibility. FE1 may retrieve the TIDX of FE0 by sending a trust index request message to the iTMF 410. If FE0 is a service producer not shown in the FIG. 4, FE0 may retrieve TIDX of FE1 from the iTMF. If FE0 and FE1 need to perform mutual trust, both FE0 and FE1 may send a trust index request to retrieve each other's TIDX from the iTMF. Mutual trust may then be established between FE0 and FE1 based on the retrieved TIDX. In an example, FE1 may send a trust index request message to the iTMF to retrieve the TIDX of FE0 410. This trust index request may include one or more parameters.

The trust index request may include a request for FE ID (RequestorFEID), which may be the identifier of the requestor FE (i.e., FE1) within the same domain as iTMF. The trust index request may include a subject FEID (SubjectFEID), which may be the identifier of the subject FE (i.e., FE0) whose TIDX the requestor FE wants to retrieve from the iTMF.

The trust index request may include a service ID (ServiceID), which may represent the identifier, name, or type of the subject service and the specific service operation that the subject FE was requesting from the requestor FE in 405. The ServiceID may have been included in the service interaction 405. The ServiceID may be involved in calculating or determining the TIDX of the subject FE. Different service operations within the same service may be each assigned a unique ServiceID. These service operations may include but are not limited to service discovery, service initialization, service invocation, service information retrieval, service offloading, service adjustment, service subscription management, and service cancellation. This parameter may include a list of ServiceIDs.

The trust index request may include a service context (ServiceContext), which may include additional service-dependent information that FE1 may provide to the iTMF to assist it in generating the TIDX of FE0. ServiceContext may include the context information about FE0 and/or FE1. An example of a ServiceContext is a ProSe WTRU-to-network Relay Service (PRS). FE1 may initiate a search for a WTRU-to-network relay to facilitate data transfer to the network. FE0, positioned between FE1 and the network, may serve as this relay. ServiceContext in this case may be: 1) FE1's throughput demand; and/or 2) FE1's requirement on latency. Those service-dependent (for WTRU-to-network-relay) parameters may subsequently inform or trigger the iTMF to estimate the relay's congestion rate, which may indirectly influence TIDX of FE0. An example of a ServiceContext is a Sensing as a Service (SaaS). FE0 may be an IoT temperature device deployed in a forest reporting a peculiar high temperature, while FE1 may be accessing FE0's data and using the TIDX of FE0 to verify its credibility. The ServiceContext in this case may include temperature data from other IoT devices physically close to FE0. While the unusual high temperature has a high change suggesting a device malfunction, leading to a low TIDX, the iTMF may identify unusual data points and record them in FEContext (as a part of an FEProfile, e.g., FEProfile: FEContext). FEProfile may be a profile the iTMF maintains locally about each FE (e.g., FE0 or FE1). Subsequently, if multiple elevated temperatures are subsequently detected across nearby devices, this may signal the onset of a forest fire and the previous low TIDX may be corrected. The following parameters may be attached to ServiceContext: Temperatures measured by other IoT devices physically close to FE0.

ServiceContext may include multiple parameters such as: ServiceType: the type of the service (e.g., “PRS”, “SaaS”, “AaaS”, “CaaS”); ServiceVersion: the current version of the service; ContextLst: a list of context items, where each context item describes a specific service context about the service, and each item may include multiple parameters such as: ContextType: the type of this specific service context; and ContextContent: the content of this specific service context.

The trust index request may include external trust conditions (ExternalTrustConditions). The external trust may be triggered by various conditions and applied on a per-request basis. These conditions may be driven either by internal rules/policies set by the iTMF and/or by specific conditions attached to the request from an external entity (e.g., FE1). Key categories of these conditions are discussed below.

An external trust information (TINFO) request may be triggered automatically by the iTMF based on pre-defined internal rules, even if no explicit condition is specified in the trust index request in 410. An external TINFO request may be triggered based on confidence. If the TIDX of FE0 that the iTMF generates locally (referred to as local TIDX), cannot meet the confidence requirements (e.g., lower than a pre-defined threshold), it is prompted to engage additional eTMFs that may be able to provide additional TINFO, which will help the iTMF re-calculate a new TIDX of FE0 with a higher confidence. Another case is that the iTMF may lack sufficient information to work out a local TIDX. An external TINFO request may be triggered based on load balancing. The iTMF may have other priorities when a trust index request arrives, prompting it to actively engage eTMFs and offload trust requests and TIDX calculation to them. An external TINFO request may be triggered based on verification. The iTMF may contact several eTMFs to verify its locally generated TIDX. By leveraging an external TINFO, the iTMF may increase the confidence of the local TIDX.

FE1 may attach or include other conditions to trigger an external TINFO request. A condition may be threshold and confidence. FE1 may request a customized threshold or confidence level that differs from the global threshold regulated by the iTMF. A condition may be a designated TMF (DesignatedTMF). FE1 may want a designated TMF to calculate the TIDX of FE0. Ensuring the use of a specific eTMF for TIDX calculation may prevent TIDX volatility, which may result from information asymmetry when using different eTMFs. By relying on a consistent TMF, FE1 may avoid unnecessary TIDX fluctuations. A condition may be a cautious rule (CautiousRule). A cautious rule may be presented as a number, denoted as n. If ‘n=0’: no external trust is required, only use the local TIDX. If ‘n>1’: the iTMF is required to request trust information from at least n eTMFs. The iTMF may select the eTMF(s) that provide the lowest TIDX among those requested, reflecting a “cautious” approach.

The trust index request may include a confidence needed (ConfidenceNeeded). This may specify whether the confidence level for the TINFO should be included in the trust index response (i.e., step 460). It may be assumed that, when a TIDX, TIDC, or TINFO is generated, a confidence is attached to or included with the result. The iTMF may not automatically attach or include the confidence of the TIDX in the response. The FE may request the confidence attached or included in the response with this ConfidenceNeeded parameter.

The trust index request may include a response timer (ResponseTimer), which may be a timer that instructs the iTMF to send the trust index response with the TIDX of FE0 (i.e., step 460) back to FE1 before this timer expires. FE1 may include this parameter to support time-sensitive services, ensuring timely communication and response for critical operations.

Upon receiving the trust index request from FE1 410, the iTMF may perform an external trust request decision 415, which may include one or more of the following operations.

The iTMF may perform FE1 authentication. The iTMF may locate FE1's profile and verify if FE1 has the authorization to retrieve FE0's trust index. The iTMF may have created the profile of FE1 (and the profile of FE0) and maintained it locally. FE1's profile may describe the list of FEs that FE1 is allowed to retrieve their trust index. This verification may be conducted through or with the aid from a PCF and/or a UDM. The iTMF may first need to verify the identity of FE1 by using the UDM or another NF. The iTMF may then consult with the PCF or another NF to confirm if FE1 may perform the TIDX request querying the TIDX of other entities such as FE0. Alternatively, the iTMF may need to generate a TIDX of FE1 first and use the TIDX of FE1 to determine whether FE1 has the authority to request the TIDX of another entity FE0.

The iTMF may perform FE0 profile identification. The iTMF may search its database to locate the FE profile of FE0 using the identifier of FE0 (i.e., SubjectFEID in step 410). The iTMF may attempt to generate the trust index of FE0 locally using its FEProfile, and other collected information on the iTMF. FEProfile may include the identifier of the FE, some context information about the FE (i.e., FEContext such as the current location of the WTRU), a list of services (i.e., SeriveIDs) that the FE may request to access or may be able to provide, a list of TIDCs that are required for evaluating the trust index of the FE for certain ServiceIDs, and a list of eTMFs that may provide additional trust information about the FE. If the necessary data is unavailable locally, the iTMF may trigger dynamic data pulling procedures to retrieve additional data from other NFs in the internal domain such as UDM, UPF, SMF, NWDAF, and/or LMF, ensuring a comprehensive and contextually accurate trust index calculation.

The iTMF may perform a context analysis (Context Analysis). The iTMF may analyze ServciceContext (attached or included in the request) and FEContext of FE0 using data analytics and/or machine learning algorithms.

A service example, from step 410, may be used here such as ProSe WTRU-to-network relay. The iTMF may compare, the FE1's demands from ServciceContext with FE0's FEContext, to find out if FE0 may be a good candidate as a WTRU-to-network relay for FE1 in terms of throughput, latency and physical location. The iTMF may also find out if FE0 is low in battery, which may prevent it from providing reliable and consistent relay service. All these factors may impact in TIDX generation of FE0.

A service example, from step 410, may be used here such as sensing as a service. The forest fire scenario illustrates the complexity of determining the TIDX, as it may be time-dependent. Initially, a low TIDX may be assigned to data that appears to result from a device malfunction. However, as the situation evolves and multiple nearby IoT devices report similarly high temperatures, the initial assessment could be revised, and the TIDX could be upgraded to a higher value, reflecting the recognition of a spreading forest fire. This highlights that initial misclassifications of a TIDX may be inevitable. To enable smart tracking of a TIDX, it is crucial to preserve key data points from the outset. Retaining important data allows AI models to analyze patterns over time and detect context changes. One effective approach for identifying critical data is to flag and store anomalous readings. These anomaly data points may be saved to FE1's profile, and potentially also to FE0's profile, ensuring that sufficient contextual information is available for future analysis and trust reassessment.

The iTMF may select external TMFs. If any condition in ExternalTrustConditions is met, the iTMF may use parameters such as RequestorFEID, SubjectFEID, ServiceID and/or ResponseTimer to select appropriate external TMFs (SelectedETMFs) from a list of trusted external domains and their eTMFs, as maintained by the iTMF, to generate TIDX collaboratively. Each parameter may be applied in a specific way. For ResponseTimer, some eTMFs may prioritize internal trust requests which may result in extended wait times for external trust information requests beyond the limit of ResponseTimer. This prolonged response may be tracked using a WaitingTimeEstimation parameter in eTMFProfile, allowing for a more informed selection of external TMFs. To address this, the iTMF must identity eTMFs with WaitingTimeEstimation that is less than ResponseTimer. For a ServiceID, among the eTMFs filtered based on ResponseTimer, the iTMF may continue to refine the selection by selecting only those eTMFs with ProvidedTrustIndicator that can satisfy the trust indicators required by ServiceID. Note that ProvidedTrustIndicator of an eTMF indicates the list of trust indicators or trust information that the eTMF may provide about an FE in general or for specific ServiceIDs. It may be assumed that the iTMF has maintained ProvidedTrustIndicator of those eTMFs or may obtain it from each eTMF via other signaling procedures between the iTMF and each eTMF. For SubjectFEID, among the eTMFs filtered based on ServiceID, the iTMF may continue to refine the selection by selecting only those eTMFs with an AssociatedFEs that includes SubjectFEID. Associated FEs may include a list of FEs that an eTMF can provide trust information about. It may be assumed that the iTMF has maintained associated FEs of those eTMFs or may obtain it from each eTMF via other signaling procedures between the iTMF and each eTMF. For RequestorFEID, if the TIDX is used for authentication to enable service access, the above filtering steps may be typically sufficient. However, if the TIDX is QoS-oriented or about QoS-related metrics, considering both FEs (FE0 and FE1) may enhance the quality of TIDX generation. In such cases, the iTMF may continue to refine the selection by selecting only those eTMFs with an AssociatedFEs that includes RequestorFEID. This ensures the TIDX generation takes into account both entities for improved performance. The iTMF may perform the above operations in a different order.

The procedures, as shown in steps 420-450, outline the process for the iTMF to retrieve the TINFO of FE0 from multiple eTMFs. External trust information requests to SelectedETMFs may be executed in parallel. Steps 420-450 may apply uniformly to all parallel requests (i.e., external trust information request).

The iTMF may send an external trust information request message 420 to an eTMF, among the SelectedETMFs in step 415. This request may include one or more of the following parameters. The external trust information request message may include iTMFID: the identifier of the iTMF. The external trust information request message may include iTMFCredential: the credential of the iTMF. The external trust information request message may include SubjectFEExternalID: the external identifier of the subject FE (i.e., FE0) that the iTMF requests trust information for. The external trust information request message may include ConfidenceNeeded: same as indicated in step 410. The external trust information request message may include RequestorExternalID: the external identifier of the Requestor FE (i.e. FE1). It may be assumed that both FEs have been associated to, bound to, registered to, or made them known to the iTMF. So, the iTMF may have this parameter (i.e., RequestorExternalID) stored locally or it may retrieve this parameter from another repository or NF (e.g., UDR). This parameter (i.e., RequestorExternalID) may be optional in the request, and the value itself may not exist if FE1 never contacted or communicated with eTMF. The external trust information request message may include RequestedTINFO: specifies the TINFO that the eTMF is required to provide for the subject FE (and/or requestor FE). The TINFO here may be specific TIDCs or a TIDX, mapped from a ServiceID using ServiceID-TINFO. ServiceID-TINFO may include a list of pairs (ServiceID, NeededTINFO), where each pair may describe one or multiple pieces of TINFO to be used for trust evaluation for a specific ServiceID. The iTMF may have built and maintained ServiceID-TINFO locally. The external trust information request message may include SecurityServiceContext: this field is censored from the ServiceContext (received from step 410), by removing unnecessary or irrelevant information for privacy protection. SecurityServiceContext may include software integrity verification: the location of FEs could be irrelevant. SecurityServiceContext may include QoS-oriented scenarios: high-level information such as latency and throughput are generally safe to share, but details such as the network topology may be too sensitive to share without proper processing. For ProSe WTRU-to-network relay, the iTMF may utilize the FEs'location to determine a TIDX. This information may be filtered as relative position to each other. The external trust information request message may include iTMFSignature: this signature states an external trust information request initiated by the iTMF, where the eTMF (the requested trust information issuer) must obtain permission from FE0 (the subject). Note that the indication about “the eTMF (the requested trust information issuer) must obtain permission from FE0 (the subject)” may be included in step 420 as a separate parameter outside of iTMFSignature. Following this, the eTMF is responsible for sending TINFO to the iTMF (the audience) which will then deliver the final TIDX or TIDCs to FE1 (the requestor). iTMFSignature may include the following parameters: Audience: the identifier of the iTMF (i.e., iTMFID); Requestor: RequestorExternalID or None (if RequestorExternalID does not exist); Subject: SubjectFEExternalID; Trust issuer: the identifier of the eTMF (ExternalTMFID), which the iTMF is contacting; SignatureID: a randomly generated identifier to differentiate different signatures. The iTMF may initial different signatures to look into different services. SignatureID may be used by a WTRU, the iTMF, and eTMF to track the authorization promoted by the signature.

Upon receiving the external trust information request 420 from the iTMF, the eTMF may assess its own capability to fulfill the external trust information request 425. The eTMF may perform several operations before sending a trust exposure request 430 to FE0.

The eTMF may first authenticate the iTMF using an iTMF credential (iTMFCredential). The eTMF may then check its local database to determine if an external trust collaboration with this iTMF has been established.

It may be assumed that FE0 has been registered with the eTMF and eTMF has created an external profile of FE0 and stored the profile in its local database (or in a repository). The eTMF may search SubjectFEExternalID (i.e., the external identifier of FE0) in its local database (or from a repository) to locate FE0's external profile, including contact details for reaching FE0. There may be multiple ways the eTMF can reach FE0, such as but not limited to: via the manufacturer's push notification server; through SMS notifications; using email notifications, among other methods; through an application-level message notification; and/or device triggers in 5GS.

The eTMF may check if RequestedTINFO fall into its capability (e.g., ProvidedTrustIndicator) range to generate a TINFO of FE0 for the iTMF.

If RequestorExternalID is attached or included in the request, the eTMF may continue to search RequestorExternalID against its database to locate the FE1's external profile. In the case of a QoS-oriented TINFO, failing to locate the FE1's external profile during TINFO generation may result in some relationship metrics fail, for example, the latency between FE0 and FE1 cannot be obtained without knowing RequestorExternalID. As a result, the eTMF may not generate a TINFO or just provide a TINFO with low confidence.

If SecurityServiceContext is attached or included in the request and the eTMF has the capability to support context analysis, the eTMF may maintain a local ServiceContext parameter. In this case, the SecurityServiceContext may be treated as an extension or add-on to the existing ServiceContext. The eTMF may then perform context analysis similar to what the iTMF did on ServiceContext in step 415.

If eTMF fails at any point above, it may move directly to step 450, sending an external trust information response and notifying the iTMF of its inability to assist TINFO generation and providing the reason to the iTMF. Otherwise, the eTMF proceeds to request trust exposure permission from FE0 in step 430.

If step 420 is not the first request from the iTMF, the eTMF may have received ExposureResidualCount and/or ExposureResidualTime (described in step 440) from step 440. The eTMF may then use ExposureResidualCount and/or ExposureResidualTime to decide to exposure FE0's trust information to the iTMF or not without the need of contacting FE0 for its consent. As such, steps 430-440 may not be needed.

If the eTMF has received iTMFLstForExposure from FE0 and the iTMF is among this list, the eTMF may also skip steps 430-440. If the iTMF is among a list of preconfigured iTMFs trustable by both FE0 and the eTMF, steps 430-440 may also be skipped.

The eTMF may send a trust exposure request message 430 to FE0 for trust exposure permission/consent for sharing FE0's trust information with the iTMF for FE0. Parameters such as the identifier of FE1, ServiceID, a list of IDs or names of TINFO to be exposed, iTMFSignature and eTMFCredential (eTMF's credential) may be included with the trust exposure request.

FE0 may verify and approve the trust exposure permission 435, which may include one or more sub steps. Since FE0 is either currently registered with or has previously registered with the eTMF, it may identify and authenticate the credentials of the eTMF. FE0 may authenticate iTMFSignature using iTMFPublicKey, the public key of the iTMF that FE0 may have obtained it. FE0 may check whether it is still requesting the service associated with ServiceID from the entity (e.g., FE1). FE0 may ensure that the sender of the trust exposure request corresponds to the specific ExternalTMFID, which it may have indicated to the iTMF during FE trust registration.

FE0 may respond (i.e. send a trust exposure response message) 440 to the eTMF with approval of the trust exposure request limited to the scope as described in iTMFSignature. FE0 may specify one or more of the following constraints to further regulate the exposure of its TINFO: ExposureResidualCount: specifies the residual number of “external trust information requests” that the eTMF is allowed to expose FE0's TINFO without the need for FE0's permission or consent; ExposureResidualTime: defines the remaining time period for which this permission remains valid (defines the residual time left for this permission); and iTMFLstForExposure: a list of one or multiple identifiers of iTMFs, which FE0 approves the eTMF to expose its trust information to those iTMF without the need for FE0's permission or consent.

Once the limits are reached in the above three constraints, the eTMF may no longer expose FE0's TINFO without obtaining a new permission. If FE0 decides to terminate the authorization earlier than the constraints defined in this step, it may notify both the iTMF and the eTMF using a iTMFSignature: SignatureID with a termination or cancel indication or indicating new conditions to the eTMF.

With the permission from FE0, the eTMF derives the requested trust information and creates a TrustThread 445, which is used to manage the entire lifecycle of the permission. This includes operations such as updating and deleting the thread. The trust thread remains active until the actual conditions exceed ExposureResidualCount and/or ExposureResidualTime, at which point the trust thread may be terminated or cancelled. TrustThread may be structured in the following format: TrustThreadID: same as iTMFSignature: SignatureID in step 415; iTMFSignature: same as iTMFSignature in step 415, regulating the trust scope; SubjectFEExternalID: same as SubjectFEExternalID in step 420, it also serves as a reference to FE0's profile in the eTMF; RequestorExternalID: same as RequestorExternalID in step 420, it also serves as a reference to FE1's profile in the eTMF; ServiceContext: indicated in step 410 and/or 420; RequestedTINFO: same as RequestedTINFO in step 420; and PermissionContraints: ExposureResidualTime, Diminished over time; and ExposureResidualCount, dwindled by one over each request.

From the eTMF's perspective, the iTMF is treated as the external TMF. It may be assume that eTMF and iTMF has performed trust collaboration establishment, as a result of which: 1) eTMF has stored iTMF's trust information in eTMFProfile maintained by the eTMF; and 2) iTMF has stored eTMF's trust information in eTMFProfile maintained by the iTMF. eTMFProfile maintains information about a TMF (e.g., the identifier of this TMF, if this TMF is trustable, the trust level of this TMF, the performance such as response time of this TMF, context information of one or multiple FEs (i.e., FEContext) that this TMF may provide trust evaluation service for).

The trust thread exists only for a limited duration following a trust exposure permission, which may be as brief as one-time, ExposureResidualCount=1. However, during TINFO generation, not only TrustThread, but parameters such as, eTMFProfile: FEContext may be considered. After initializing the trust thread, the eTMF may continue to generate the TINFO in accordance with the scope and content defined by the trust thread (e.g., RequestedTINFO received from step 420). If the eTMF operates as a TMF within a PLMN, its behavior may mirror that of an iTMF, pulling the necessary data from other NFs to ensure robust TINFO generation, as outlined in step 420.

As a result of step 445, some TINFO of FE0 as requested by the iTMF is generated by the eTMF.

After receiving the trust exposure response 440 indicating that FE0 approved the trust exposure request, the eTMF may use the same trust exposure response to serve future external trust information request from the same iTMF (or other iTMFs) without contacting FE0 again for consent or permission, as such steps 430-440 may be skipped future.

The eTMF may send an external trust information response message 450 to the iTMF. This response may include the TINFO of FE0 generated and derived in step 445 by the eTMF and one or more other parameters. The response may include TINFO, which may be a trust information about FE0 as derived in step 445. If TINFO is a TIDX, it may be a scale value. If TINFO is a TIDC, it may include a set of values representing different metrics. The response may include TrustConfidence, which may indicate the eTMF's level of confidence for the TINFO if ConfidenceNeeded is TRUE in step 410 The response may include IsFE1Recognized, which may be a Boolean value indicating whether FE1 is recognized by the eTMF in step 425. If True, it signifies that FE1 is recognized and if False, FE1 is not recognized. In a QoS-oriented TINFO, a lack of recognition for FE1 is likely to result in a low TrustConfidence.

After collecting responses from all SelectedETMFs or ResponseTimer expires, the iTMF may re-evaluate the collected TINFO with locally generated TINFO to produce the final TIDX of FE0 455. As indicated with ServiceID-TINFO which the iTMF has maintained locally, the mapping may be service-dependent, not TMF-dependent, which means the requested TINFO is invariant to the requested iTMF. This step may include following sub steps: TINFO Filtering, where TINFOs with confidence levels below a predefined threshold may be filtered out; and Final TIDX Generation, where the iTMF takes different evaluation methods for each received TIDC or TIDX.

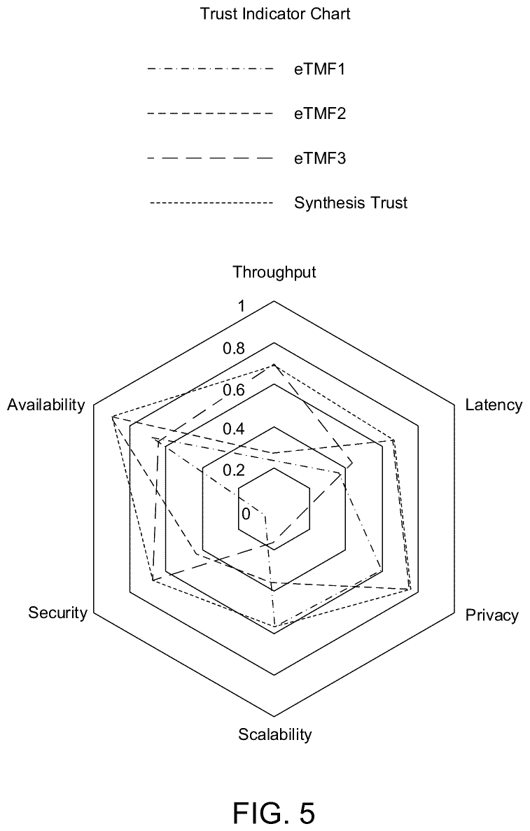

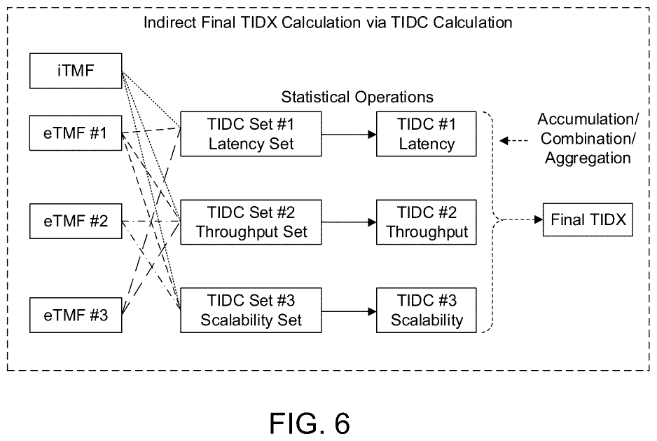

For a first case (Case 1) of Final TIDX Generation, an Indirect Final TIDX calculation may be performed via TIDC calculation. The iTMF may use statistical methods (such as averaging, taking the median, selecting the minimum value, and/or selecting the maximum value over the values collected from different eTMFs) to each TIDC set. A TIDC set may be defined as the same TIDC provided by different eTMFs. Afterward, it may sum or aggregate all the trust indicators to determine the final TIDX. FIG. 5 shows an example of the process with three sets of TIDC values obtained from three different eTMFs, where each provides the same indicators. However, this is not a requirement and the indicators provided by the eTMFs may be asymmetric. FIG. 5 shows the approach of maximizing each indicator before summing them to calculate the final TIDX. FIG. 6 shows the pipeline of indirect final TIDX calculation via TIDC calculation.

In a ProSe use case, FE1 may aim to identify a device capable of delivering high throughput and low latency, which are represented by two distinct trust indicators. In such a scenario, the iTMF may choose to take the maximum value of each trust indicator (e.g., throughput and latency) and then sum or aggregate them. This approach accounts for the fact that these trust indicators may be managed by different eTMFs.

In another ProSe use case, to measure whether FE0 may be a good WTRU-to-Network relay to forward network traffic for FE1, a selected eTMF (from different domains) may measure its latency to FE1 via FE0 as one of the trust indicators. In this case, the iTMF may calculate the average value of the latency indicator to assist FE1 in selecting the best relay, ensuring balanced performance across the selected domains.

In continuing the FL client registration use case, the iTMF may aggregate these indicators by calculating/computing/determining the median of the values in each indicator set. Subsequently, the aggregated values across all indicators may be summed to calculate the final trust index, The trust indicators may be: TIDC #1: FE connectivity, from iTMF; TIDC Set #2: FE FL client training data diversity, from eTMFs; TIDC Set #3: FE FL client contribution score, from eTMFs; TIDC Set #4: FE honesty index, from eTMFs.

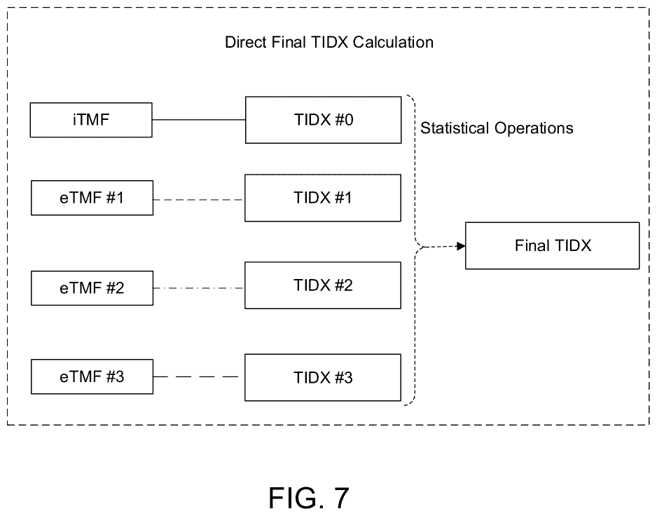

For a second use case (Case 2) of Final TIDX Generation, a Direct TIDX Calculation may be performed. The iTMF may compute/calculate/determine the final TIDX directly by aggregating TIDX received from eTMFs using methods such as averaging, taking the median, selecting the minimum value, and/or selecting the maximum value as shown in FIG. 7. The action choice motivation is similar to the motivation in TIDC calculation.

Based on the interactions between the iTMF and eTMFs, the iTMF may update the eTMFProfile of the eTMF as part of ongoing maintenance. Some of the updating parameters may be: eTMFProfile, which may include: TMFID: the identity of the eTMF; TrustStatus: this may change over time if the eTMF is removed from the trusted party (TP) list or not trusted by any TP; WaitingTimeEstimation: this parameter may be updated to reflect the most recent response waiting time; eTMFTrustLevel: the iTMF may measure and update the level of its trust on each eTMF that the iTMF has been interacting with.

The iTMF may send a trust index response message 460 to FE1 as a response to the trust index request initiated in step 410. This response may include the final TIDX determined in step 455. Confidence for the TIDX may be attached or included if specified by ConfidenceNeeded in step 410.

The final TIDX may be applied to the service interaction between FE0 and FE1 465.

For feedback, FE0 may provide feedback on FE1 to the iTMF, and similarly, FE1 may provide feedback on FE0. Based on this mutual feedback, the iTMF may dynamically update the TIDX of FE0 for FE1 and/or update the TIDX of FE1 for FE0, reflecting the evolving and dynamic trust relationship between FE0 and FE1.

For reiterated trust request, since TIDX is a time-variant parameter, either FE0 or FE1 may request an updated TIDX of each other from the iTMF (i.e., repeat steps 410-460 for one-time request or for subscription expecting to receiving repeated notifications of each other's TIDX from the iTMF). This ensures that the TIDX remains accurate and relevant during ongoing interactions.

For additional eTMF, if the TIDX is lower than a pre-defined threshold, it may be attributed to the absence of a necessary eTMF. In this case, FE0 may initiate an FE trust registration update to register additional eTMFs to the iTMF. Subsequently, FE0 may re-request FE1 to re-initialize the trust index request to the iTMF to incorporate the newly registered eTMF, potentially improving the TIDX.

When a WTRU is either newly introduced to the 6G serving network or engages in a new activity within it, the iTMF in the 6G serving network may lack sufficient information to evaluate the trustworthiness of the WTRU for accessing a specific service. In such cases, an eTMF in an external domain (e.g., WTRU's home network or an AF in a DN) may possess the necessary data and may provide additional trust information about the WTRU. Depending on the way for providing additional trust information to the iTMF, the following three embodiments are proposed.

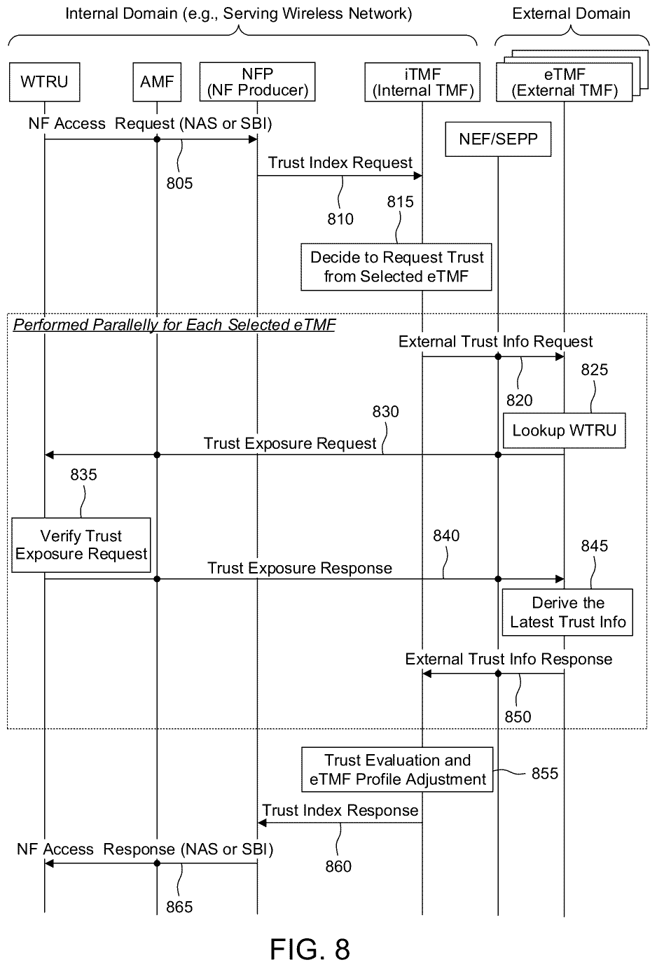

In embodiment #1, the iTMF may pull or retrieve additional trust information about the WTRU from eTMFs. The iTMF may then incorporate the pulled trust information into a trust evaluation for the WTRU. An example of embodiment #1 is shown in FIG. 8.

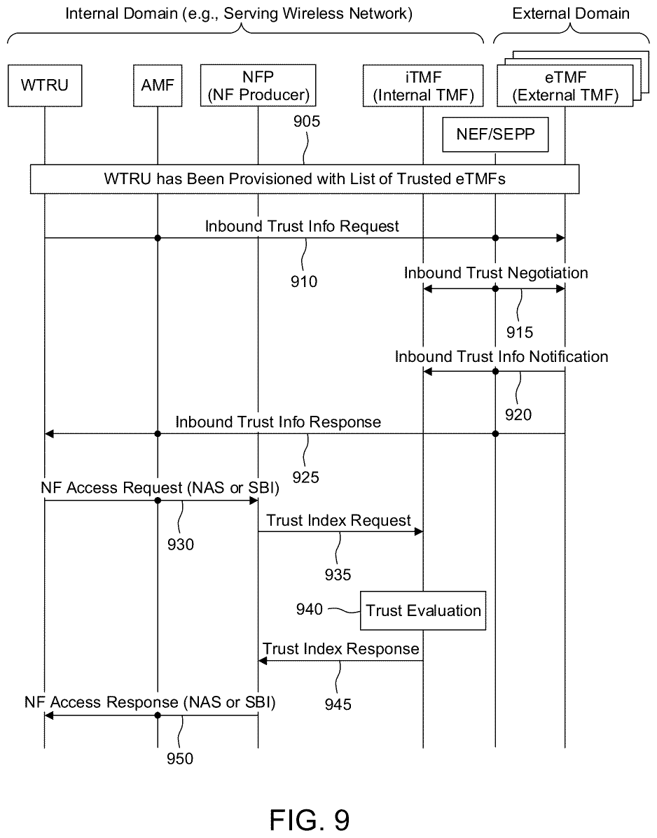

In embodiment #2, the WTRU may request the eTMFs to push additional trust information about the WTRU to the iTMF. The iTMF then may use the pushed trust information into a trust evaluation for the WTRU. An example of embodiment #2 is shown in FIG. 9.

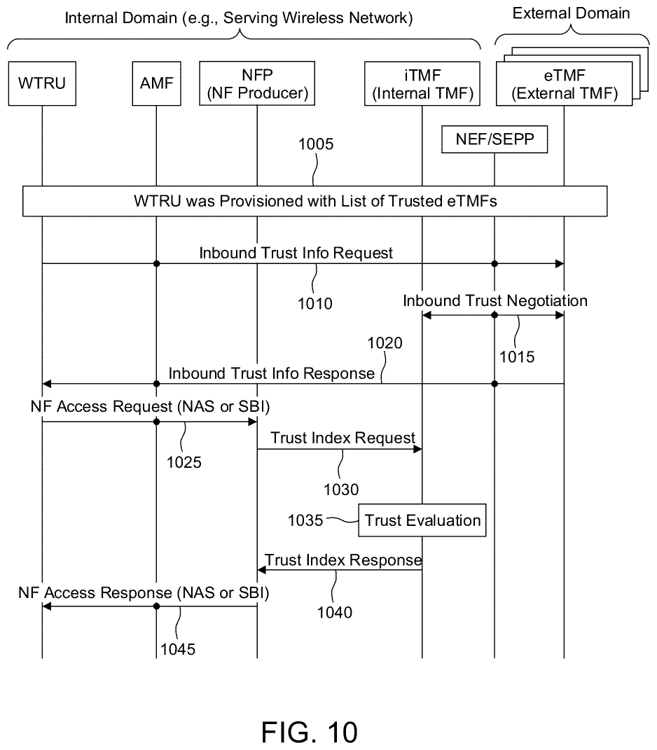

In embodiment #3, The WTRU may pull or retrieve additional trust information about itself directly from eTMFs. The pulled trust information may be used as the final trust index of the WTRU and may be presented from the WTRU to a NFP. Otherwise (i.e., the pulled trust information is not the final trust index), the WTRU may present the trust information to the NFP/iTMF and the iTMF may incorporate the trust information into a trust evaluation for the WTRU. An example of embodiment #3 is shown in FIG. 10.

In embodiment #1, an iTMF pulls or retrieves additional trust information from eTMFs. FIG. 8 shows the interaction procedure between the wireless network (e.g., a PLMN or NPN) and external domains (such as PLMN, NPN and/or AF in DN), highlighting how the iTMF leverages the input from these collaborators (i.e., eTMFs) to generate a TIDX for internal operations requested by a WTRU. FIG. 8 includes the following logic entities or actors. A WTRU may be a mobile device and/or a user which requests to access services provided by a NFP. A NFP may be a NF producer which provides services to a WTRU. The NFP may reside in a part of the serving wireless network (e.g., base station, 6G edge network, 6G core network, or a 6G device/WTRU). The NFP may be an AMF. An iTMF may be the TMF in the serving wireless network of the WTRU, such as a serving 6GS. The eTMFs may be the TMFs in a non-serving wireless network, and may be a DN and/or the home wireless network of the WTRU. An AMF may be an access and mobility management function in the serving wireless network of the WTRU. The AMF in 6GS may have a different name or embedded in a new 6G NF. A NEF may be a network exposure function in the serving wireless network of the WTRU. The NEF may serve as a bridge for wireless network (WN)-with-AF communication. The NEF in 6GS may have a different name or embedded in a new 6G NF. An SEPP may be a security edge protection proxy connecting the serving wireless network and the home wireless network. The SEPP may handle WN-with-WN communication. The SEPP in 6GS may have a different name or embedded in a new 6G NF. A NEF/SEPP may be in the cross-domain concept, both scenarios are accounted for, and NEF and SEPP are collectively referred to as NEF/SEPP.

The steps in the procedure shown in FIG. 8 closely align with those outlined in FIG. 4, where FE0 and FE1 in FIG. 4 may correspond to the WTRU and NFP, respectively, as shown in FIG. 8.

Another difference is the communication between the WTRU and eTMF, which may be done through various ways. In a WN-with-WN cross-domain scenario (e.g., iTMF in a visited PLMN and eTMF in a home PLMN), WN (wireless network) may be, for example, PLMN, NPN, CPN, PIN, WiFi. The communication may be proxied and forwarded by SEPP (e.g., with forwarding policies configured by iTMF) using NAS and/or SBI. In a WN-with-AF cross-domain scenario (e.g., iTMF in a serving PLMN and eTMF as an AF/AS in a DN), WN (wireless network) may be, for example, PLMN, NPN, CPN, PIN, or WiFi. The communication may be forwarded by the NEF (e.g., with forwarding policies configured by iTMF). The communication goes through a data plane, such as: (i) from eTMF to WTRU: eTMF request consent by pushing an application notification for the WTRU/user to approve; (ii) from WTRU to eTMF: after receiving the notification, the WTRU/user may evaluate it and generate a consent, which may be transmitted to the eTMF.

The description below for FIG. 8 primarily focuses on the scenario where the NFP requests the TIDX of the WTRU to determine its service accessibility. However, a similar approach (e.g. WTRU requests to the iTMF for NFP's TIDX) may be applied to the scenario where the WTRU requests the iTMF to verify the legitimacy of the NFP (e.g., generate the TIDX of the NFP and share it with the WTRU). While this second scenario may seem unrealistic under current 5G standards since all NFs are hosted in MNO's domain and may be trusted, it becomes more plausible in a 6G context. In the future 6GS, an NFP may be embedded on/in a WTRU, and that WTRU may be roaming from a different domain, making it essential to verify the legitimacy of the NFP.

The following description highlights the key parameters exchanged between entities and the differences compared to the solution in FIG. 4. It is assumed that the NEF/SEPP has been configured to forward external trust requests and responses between eTMFs and the iTMF. It is also assumed that the trust collaboration between the iTMF and eTMFs may have been established.

Steps 805-815 in FIG. 8 outline the procedures triggered when a trust index request, initiated by a service interaction, reaches the iTMF. If the iTMF is unable to generate a trust index to facilitate the service interaction, it may select external TMFs (eTMFs) and contact them for additional trust information about the WTRU.

A WTRU may request a service from an NFP by sending an NF access request message to the NFP 805. In 5GS, this request may be conveyed using NAS signaling, while in 6GS, it may be transmitted via service-based interface (SBI) or other messaging approaches to be defined in 6GS. The NF access request message may include parameters such as, for example, a WTRU ID (WTRUID), a WTRU credential (WTRUCredential), a WTRU context (WTRUContext), EDList, ServiceID, and other service-specific parameters, which may include the WTRU's hardware specifications and power source. The WTRUID may be an identifier of the WTRU (e.g., subscription concealed identifier (SUCI)). The WTRUID may also include an identifier of the user that uses the WTRU to access the serving network. The WTRUCredential may be a credential of the WTRU, which may include a user credential. The WTRUContext may be the contextual information about the WTRU, which may include one or more of the following information. The WTRUContext may include a WTRU location (WTRULocation), which may be a physical location of the WTRU, network location of the WTRU, identifier of the point of attachment of the WTRU, or physical region of the WTRU. The WTRUContext may include a WTRU connection type (WTRUConnectionType), which may indicate various type of connections (e.g., cellular, Wi-Fi, satellite) that the WTRU may connect to the core network. The WTRUContext may include a WTRU power supply source (WTRUPowerSupplySource), which may be powered by, for example, battery, cable, or solar. The WTRUContext may include a WTRU type (WTRUType), which may be, for example, an IoT device, smart phone, vehicle, drone, or aviator. The WTRUContext may include a WTRU hardware specification information (WTRUHardwareSpecification), which may indicate, for example, the type/model/capability/size of memory, the type/capability/model of the computing processor, or the type/model/capability/size of storage. The EDList may be a set of mapping pairs between an eTMF ID and the WTRU's external ID (e.g., generic public subscription identifier (GPSI)). Each pair may describes an eTMF.

For example, if the WTRU is registering as an FL client on the NFP, the hardware specifications may be used to allocate appropriate computational tasks, while the power source helps determine the FL task load. For example, WTRUs with main power can handle more computational tasks compared to those relying on battery power.

If the NF access request message 805 includes an EDList, it aims to support a more comprehensive trust evaluation. The EDList may be required in several scenarios. The EDList may be required in enhancing trustworthiness, where the WTRU determines that the iTMF lacks sufficient data or required eTMFs to assess its trustworthiness, prompting the attachment or inclusion of additional eTMFs to demonstrate its trustworthiness. The EDList may be required in responding to service-specific criteria, where the WTRU has already completed steps 805-865 once, but the resulting TIDX was not higher than a threshold to enable the service. Therefore, the WTRU may provide new trust-related information to improve its trust assessment.

After the NFP verifies the credential of the WTRU, the NFP may request the trust index from iTMF for the WTRU. The NFP may have been provisioned with the address of the iTMF. Otherwise, the NFP may discover the iTMF from a NRF or other NFs. The NFP may send a trust index request message 810 to the iTMF to retrieve the TIDX of the WTRU, which is similar to step 410 of FIG. 4. The trust index request message may include one or more of the following parameters, as described as a part of step 410 of FIG. 4 and some parameters received from step 805. The trust index request message may include a WTRU ID (WTRUID), which may be the identifier of the WTRU. The trust index request message may include a WTRU context (WTRUContext), as received from step 805. The trust index request message may include an NFP ID (NFPID), which may be the identifier of the NFP. The trust index request message may include a service ID (ServiceID), which may be the same as ServiceID in step 410 of FIG. 3, which may be the identifier of the service that the WTRU requested to access from the NFP. The trust index request message may include the service context (ServiceContext), which may be the same as ServiceContext in step 410 of FIG. 4. The trust index request message may include the external trust conditions (ExternalTrustConditions), which may be the same as ExternalTrustConditions in step 410 of FIG. 4. The trust index request message may include a confidence attached (ConfidenceAttached), which may be the same as ConfidenceAttached in step 410 of FIG. 4. The trust index request message may include a notify timer (NotifyTimer), which may be the same as NotifyTimer in step 410 of FIG. 4. The trust index request message may include an EDList, which may be the same as EDList in step 805.

There may be a scenario where multiple WTRUs request services from the same NFP. As such, the NFP may need to obtain a trust index of each of those WTRUs from the iTMF. The NFP may repeat step 810 multiple times, one for each WTRU. Alternatively, the NFP may perform step 810 once to obtain the trust index of all those WTRUs. In this case, step 810 may include multiple sets of those parameters as described above and each parameter set is in reference to a different WTRU.

Upon receiving the trust index request from the NFP, the iTMF may prepare external trust information requests to eTMFs 815. The descriptions of these requests are similar to those in step 415 of FIFG. 4, with the primary distinction being the potential inclusion of an EDList. If some eTMFs listed in the EDList do not have profiles created by the iTMF, it may be necessary for the iTMF to create profiles for them. Once these profiles are established, the iTMF may associate the WTRU's profile with the eTMFs listed in the EDList. Following this, the iTMF may need to determine or select one or more eTMFs (referred to as SelectedETMFs) from the set of trusted eTMFs associated with the WTRU. The selected eTMFs will be contacted in step 820 to obtain additional trust information for the WTRU.

The procedures in steps 820-850 outline the process for an iTMF to retrieve the TINFO of a WTRU from multiple eTMFs. External trust information requests to SelectedETMFs are executed in parallel. The following steps apply to each selected eTMF.

The iTMF may send an external trust information request 820 to an eTMF among the SelectedETMFs via a SEPP for a WN-with-WN scenario, or an NEF for a WN-with-AF scenario. The eTMF may require permission from the WTRU to expose its trust information. For this purpose, an iTMF signature may be included to streamline the permission process. The external trust information request may include one or more of the following parameters. The external trust information request may include an iTMF ID (iTMFID), which may be the identifier of iTMF. The external trust information request may include an iTMF credential (iTMFCredential), which may be a credential of the iTMF. The external trust information request may include a WTRU external ID (WTRUExternalID), which may be the external identifier of the WTRU which may be understood by the eTMF. The external trust information request may include a NFP external ID (NFPExternalID), which may be the NFP's identifier and may be recognized by the eTMF. The presence of the NFPExternalID is optional. If the NFP is a traditional CN NF, it may not have an external ID. However, an external ID may exist if the NFP is embedded on or in a WTRU, which is a plausible scenario in 6G. Regardless of the definition or role of the NFP (e.g., 5G NF or 6G WTRU with embedded NFs), it is assumed that the NFP may register itself with the iTMF. The external trust information request may include a requested trust information (RequestedTINFO), which may be the same as the description for RequestedTINFO in step 420 of FIG. 4. The external trust information request may include a security service context (SecurityServiceContext), which may be the same as the description for SecurityServiceContext in step 420 of FIG. 4. Step 820 may also include other parameters as included in step 420 of FIG. 4. The external trust information request may include an iTMF signature (iTMFSignature), which may be similar to the description for iTMFSignature in Step 420 of FIG. 4.

Note that if step 810 includes multiple parameter sets (e.g., one for a different WTRU), step 820 may also include multiple parameter sets (e.g., one for a different WTRU).

It is assumed that the WTRU has been registered to the eTMF with its external identifier WTRUExternalID and the eTMF has created a WTRU profile for the registered WTRU. The eTMF may look into or search its database or from another NFs which stores WTRU profiles to find the WTRU profile associated with WTRUExternalID 825. Upon receiving the external trust information request 820 from the iTMF, the eTMF may assess its own capability to fulfill the external trust information request. The eTMF may perform several operations before sending a trust exposure request 830 to the WTRU, and the eTMF may perform the same or similar steps as in step 425 of FIG. 4 as discussed above.

Step 830-840 describe the process where the eTMF requests the WTRU's consent to exposing the WTRU's TINFO from the eTMF to the iTMF. The trust exposure request 830 may be transmitted in various ways, as discussed above regarding communication between the WTRU and eTMF. The other details steps are the same as step 430-440 of FIG. 4. Steps 830-840 may be repeated for each WTRU, if step 820 includes multiple parameter sets (e.g., one for a different WTRU).

Step 845-860 are similar to Step 445-460 in FIG. 4. Note that step 850 may include trust information of multiple WTRUs, especially if step 820 included multiple parameter sets (e.g., one for a different WTRU).

Upon receiving the TIDX of the WTRU from the iTMF in the trust index response message 860, the NFP may evaluate the TIDX with a service access threshold, and may send a response to the WTRU, in a NF access response message 865, indicating if the NF access request is approved. In 5GS, this response may be conveyed using NAS signaling, while in 6GS, it may be transmitted via service-based interface (SBI) or other messaging approaches to be defined in 6GS. The NF access response message may include one or more parameters. The NF access response message may include an access service approvement (AccessServiceApprovement), which may be a Boolean value that indicates if the request is approved or denied/failed. The NF access response message may include a service message (ServiceMessage). If the NF access request in step 805 requests certain information, ServiceMessage may include the requested information. The NF access response message may include a failed reason (FailedReason). If the access service approvement indicates a failure or denial (e.g., ‘AccessServiceApprovement=failed’), the NFP may indicate to the WTRU why the request is declined. In addition, the NFP may also instruct the WTRU to indicate additional EDList to the iTMF and/or providing additional trust information about the WTRU. The WTRU may then perform the procedure as shown in FIG. 10 (i.e. the WTRU provides trust information to the eTMF).

In an embodiment, a WTRU may be configured to perform functionalities, as show in FIG. 8. The WTRU may receive, or be pre-configure with, trust management function (TMF) configuration information. The TMF configuration information may include information regarding an internal TMF (iTMF) and at least one external TMF (eTMF). The information may be an identifier and/or contact information for each of the at least one eTMF and an identifier and/or contact information of the iTMF.

The WTRU may send a network function (NF) access request message 805 to a first network node. The first network node may be a network function producer (NFP). The NF access request message may be sent using NAS signaling. The NF access request message may be sent via a service-based interface (SBI). The NF access request message may include the WTRU's 3GPP identifier (e.g., SUCI, a subscription permanent identifier (SUPI), a globally unique temporary identifier (GUTI), or an International Mobile Subscriber Identity (IMSI)). The WTRUs'3GPP identifier may be the WTRU's internal identifier (i.e. identifier used in the internal domain). The NF access request message may include the WTRU's external identifier (e.g., GPSI). The WTRU's external identifier may be the identifier used in the external domain. The NF access request message may include a service identification (ServiceID) indicating the service the WTRU is requesting. The NF access request message may include parameters such as, for example, a WTRU ID (WTRUID), a WTRU credential (WTRUCredential), a WTRU context (WTRUContext), EDList, and other service-specific parameters, which may include the WTRU's hardware specifications and power source.

The WTRU may receive a trust exposure request message 830 from a second network node. The second network node may be an eTMF. The trust exposure request message may be a request for permission or consent to share the WTRU's trust information with an iTMF. The trust exposure request message may include an identifier of the second network node. The trust exposure request message may include an the identifier of a third network node. The third network node may be an iTMF. The trust exposure request message may include a ServiceID.

The WTRU may verify the trust exposure request 835. The WTRU may verify or determine that the identifier of the second network node is among or matches one of the preconfigured eTMFs identifiers. The WTRU may verify or determine that the identifier of a third network node matches the preconfigured iTMF identifier. The WTRU may verify or determine that the ServiceID in the trust exposure request message is equal to or matches the ServiceID in the NF access request message.

The WTRU may send a trust exposure response message 840 to the second network node (i.e., eTMF). The trust exposure response message may be or include an indication for permission for the eTMF to expose the WTRU's trust information to the third network node (i.e., iTMF). The trust exposure response message may include an exposure residual count parameter that indicates the residual number of “external trust information requests” that the eTMF is allowed to expose the WTRU's trust information. The trust exposure response message may include an exposure residual time parameter that defines the remaining time period for which this permission remains valid. The trust exposure response message may include an iTMF list for exposure parameter, that is a list of one or multiple identifiers of iTMFs, which the WTRU approves the eTMF to expose its trust information to those iTMF without the need for the WTRU's permission or consent. Once the limits are reached in the above three constraints, the eTMF may no longer expose the WTRU's trust information without obtaining a new permission. If the WTRU decides to terminate the authorization earlier than the constraints defined above, the WTRU may notify both the iTMF and the eTMF with a termination or cancellation indication.

The WTRU may receive a NF access response message 865 from the first network node (i.e., NFP). The NF access response message may indicate whether the NF access request is approved or granted. The NF access response message may include an access service approvement parameter, which may be a Boolean value that indicates if the request is approved/granted or denied/failed. The NF access response message may include a service message with requested information, if such a request was included in the NF access request message. The NF access response message may include a failed reason parameter that may indicate why the request is denied. The NFP may also instruct the WTRU to indicate additional EDList to the iTMF and/or provide additional trust information about the WTRU.

In embodiment #2, a WTRU requests an eTMF to push trust information to an iTMF. In FIG. 8, the iTMF requests or pulls a TINFO of the WTRU from eTMFs. Alternatively, the WTRU may actively request eTMFs to send its TINFO to the iTMF, as shown in FIG. 9. The following logic entities or actors are shown in FIG. 9. A WTRU may be a mobile device and/or a user which requests to access services provided by a NFP. A NFP may be a NF producer which provides services to the WTRU. The NFP may reside in a part of a wireless network (e.g., base station, 6G edge network, 6G core network, or a 6G device/UE). The NFP may be an AMF. An iTMF may be a TMF in the serving wireless network of the WTRU, such as a 6GS. An eTMF may be a TMF in a non-serving wireless network, and may be DN and/or the home wireless network of the WTRU. An AMF may be an access and mobility management function in the serving wireless network of the WTRU. The AMF in 6GS may have a different name or embedded in a new 6G NF. A NEF may be a network exposure function in the serving wireless network of the WTRU. The NEF may serve as a bridge for WN-with-AF communication. The NEF in 6GS may have a different name or embedded in a new 6G NF. A SEPP may be a security edge protection proxy connecting the serving wireless network and the home wireless network. The SEPP may handle WN-with-WN communication. The SEPP in 6GS may have a different name or embedded in a new 6G NF. A NEF/SEPP may be in a cross-domain concept, and both scenarios may be accounted for, and the NEF and SEPP may be collectively referred to as NEF/SEPP.

During step 905, e.g., as part of WTRU registration, the network (e.g., AMF, iTMF, other NFs, AF (Application Function), and/or AS (Application Server)) may provision the WTRU with one or more parameters (e.g. the WTRU may receive provision information). The WTRU may be provisioned (e.g., by AF/AS) with a list of trusted eTMFs, which may be eTMFs that are trusted by the iTMF. For example, there may be a business relationship that has been established between the internal domain and the external domain. In another example, trust collaboration may have been established between the iTMF and the eTMFs. In another example, the iTMF may have been configured with the trustable eTMFs. In another example, the eTMFs may have been indicated to the iTMF by other WTRUs. The iTMF may have verified the eTMFs and may know that they may be used for the requestor WTRU. The WTRU may be provisioned (e.g., by AF/AS) with inbound-enabled services for each eTMF. For each trusted eTMF, the network may specify a subset of inbound-enabled ServiceIDs. Inbound-enabled services are the services that may be enabled by using the TINFO pulled by the WTRU from eTMFs.

The inbound trust may be utilized for different scenarios. The inbound trust may be used in an unregistered entity trust scenario, where the WTRU did not complete trust registration with the iTMF. This may occur if: the iTMF rejected the WTRU's trust registration request, or if the WTRU did not initiate trust registration. As a result, the iTMF cannot provide a trust evaluation for the WTRU, but inbound trust from a trusted eTMF may fill this gap. The inbound trust may be used in a partial registration scenario. The WTRU may have completed trust registration with the iTMF, but did not associate with the specific eTMF required for a new activity or service. In this case, the iTMF may not have sufficient trust information to assess the WTRU's trustworthiness for the new service. However, the inbound trust proof from relevant eTMFs may still be used by the iTMF to support the trust evaluation process for the WTRU.

The WTRU may request inbound trust information from an eTMF, by sending an inbound trust information request message 910. The inbound trust information request message may be sent to an eTMF selected from the list of trusted eTMFs provided during provisioning. The inbound trust information request message may also be transmitted to the eTMF using the control plane or user plane of the serving wireless network. The inbound trust information request message may include one or more parameters. The inbound trust information request message may include an iTMF ID (iTMFID), which may be the identifier of the iTMF. The inbound trust information request message may include a WTRU ID (WTRUID), which may be the WTRU's identifier, which may be recognized by iTMF. The inbound trust information request message may include a WTRU external ID (WTRUExternalID), which may be the WTRU's external domain identifier, which may be recognized by the eTMF. The inbound trust information request message may include a WTRU credential (WTRUCredential), which may be a credential of the WTRU, which may be used by eTMF to verify legitimacy of the WTRU. The inbound trust information request message may include a NFP ID (NFPID), which may be the NFP's identifier that may be recognized by the eTMF. Since the WTRU aims to access services from the NFP in step 930, it is assumed that the WTRU knows the NFP or has discovered the NFP before step 910 or as a part of step 905. The inbound trust information request message may include a NFP external ID (NFPExternalID), which may be the NFP's identifier that may be recognized by the eTMF. The presence of NFPExternalID is optional. If the NFP is a traditional CN NF, it may not have an external ID. However, an external ID may exist if the NFP is embedded on or in a WTRU, which is a plausible scenario in 6G. The inbound trust information request message may include a service ID (ServiceID), which may be a service identifier, acquired during the initial provision, which may be recognized by the iTMF. The eTMF cannot recognize or understand its meaning, but it is aware of the corresponding TINFO with ExternalServiceID-TINFO. The WTRU may also request a service type outside the initial provision. The inbound trust information request message may include a WTRU signature (WTRUSignature), which may be a statement initialized by the WTRU to the iTMF via the TMF indicating that the WTRU (the requestor) is requesting the eTMF (the trust issuer) to push the TINFO of WTRU (the subject) to the iTMF (the audience). The TINFO may be mapped from the ServiceID (the trust scope) and the WTRU may interact with the NFPID (the interactor). The WTRUSignature may include one or more of: Audience: iTMFID; Requestor: WTRUID, WTRUExternalID; Subject: WTRUID, WTRUExternalID; Interactor: NFPID, NFPExternalID; Trust issuer: ExternalTMFID; Trust scope: ServiceID; InboundRequestID: a unique randomly generated identifier used by the iTMF to match the upcoming TIDX request from the NFP with the pre-delivered TINFO received from the eTMF. This InboundRequestID may be passed to the iTMF from the WTRU via the eTMF.

Upon receiving the inbound trust information request, the eTMF may perform inbound trust negotiation 915 and may identify the WTRU with WTRUExternalID and authenticate the WTRU with WTRUCredential. If the ServiceID is not recognizable by the eTMF, the eTMF may reach out to iTMF for inbound trust negotiation by presenting the unrecognizable ServiceID to the iTMF, which may send a list of TINFOs needed for the ServiceID to the eTMF.

The eTMF may send the WTRU's TINFO to the iTMF in an inbound trust information notification message 920, signaling that the TINFO will be applied to an upcoming trust information request from the NFP with InboundRequestID. The parameters included in the inbound trust information notification message, sent from the eTMF to the iTMF, may include one or more of: TINFO: TINFO of the WTRU; WTRUSignature: which may be the same as WTRUSignature in step 910; ExpirationPeriod: since the TINFO could not be immediately consumed, the TINFO may expire after the ExpirationPeriod, which may be determined by some policies at the iTMF; InboundRequestID: which may be the same as InboundRequestID in step 910, and may be not only the same definition, but also the same number.

There may be a scenario where multiple WTRUs are requesting inbound trust information from the same eTMF. As such, the iTMF may repeat step 915 and step 920 multiple times, one for each WTRU, with the iTMF. Alternatively, the eTMF may perform step 915 and step 920 once for all WTRUs. In this case, step 915 may include multiple sets of those parameters as described above in step 915 and each parameter set is for a different WTRU Also, step 920 may include multiple sets of those parameters as described above in step 920 and each parameter set is for a different WTRU.

The eTMF may send an inbound trust information response message 925 to the WTRU with InboundRequestID, also indicating the status of the TINFO delivery. This response may inform the WTRU of one of the following outcomes: Failure: the eTMF failed to negotiate or deliver the TINFO to the iTMF, or Success: the TINFO has been successfully delivered to the iTMF, and the trust information is available for the pending WTRU trust request. In this case, the InboundRequestID is included to facilitate request tracking and matching. This feedback (i.e., the inbound trust information response) allows the WTRU to be aware of the current state of the trust negotiation process, enabling the WTRU to take further actions if needed (e.g., reinitiate the request or seek alternative eTMFs).

The WTRU may initiate an NF access request to the NFP. The WTRU may send an NF access request message 930 to the NFP. The NF access request message may include the parameters included in step 805 of FIG. 8. The NF access request message may also include the InboundRequestID. The NF access request may include one or more of: WTRUID: same as WTRUID in step 805 of FIG. 8; WTRUCredential: same as WTRUCredential in step 805 of FIG. 8; ServiceID: same as ServiceID in step 805 of FIG. 8; InboundRequestID: the InboundRequestID used in step 910; other service-specific parameters (e.g., contained in step 805 of FIG. 8).

The NFP may send a trust index request message 935 to the iTMF. The trust index request message may include the parameters indicated in step 810 of FIG. 8 and/or parameters indicated in step 930, along with the same InboundRequestID. The trust index request message may include one or more of: WTRUID: the WTRUID received in step 930; NFPID: the identifier of NFP; ServiceID: the ServiceID received in step 930; ServiceContext: same as ServiceContext in step 810 of FIG. 8; ConfidenceAttached: same as ConfidenceAttached in step 810 of FIG. 8; InboundRequestID: the InboundRequestID received step 930.

The iTMF may perform a trust evaluation 940. The iTMF may identify a previously cached TINFO associated with InboundRequestID. Before using this TINFO, the iTMF may ensure its validity by checking if the expiration time has not been exceeded, using the ExpirationPeriod in step 920, as the reference. The iTMF may then evaluate the final trust index of the WTRU (TIDX) using the similar step 855 of FIG. 8.

The iTMF may send a trust index response message 945 to the NFP. The trust index response message may include the TIDX calculated in step 940.

The TIDX may be applied to the NFP to determine the NF access from the WTRU. The NFP may send an NF access response message 950 to the WTRU. This step is similar to step 865 of FIG. 8.

In embodiment #3, a WTRU provides trust information to an iTMF.

FIG. 10 shows a procedure that a WTRU may perform when facing the same situation described in FIG. 9. Instead of asking eTMFs to push a TINFO to the iTMF, the WTRU may pull or receive the TINFO to itself and then present it to the NFP. FIG. 10 includes the following logic entities or actors. A WTRU may be a mobile device and/or a user which requests to access services provided by a NFP. An NFP may be a NF producer which provides services to a WTRU. The NFP may reside in a part of a wireless network (e.g., base station, 6G edge network, 6G core network, or a 6G device/WTRU). The NFP may be an AMF. An iTMF may be a TMF in the serving wireless network of the WTRU, such as a 6GS. An eTMF may be a TMF in a non-serving wireless network, and may be a DN and/or the home wireless network of the WTRU. An AMF may be an access and mobility management function in the serving wireless network of the WTRU. The AMF in 6GS may have a different name or embedded in a new 6G NF. An NEF may be a network exposure function in the serving wireless network of the WTRU. The NEF may serve as a bridge for WN-with-AF communication. The NEF in 6GS may have a different name or embedded in a new 6G NF. A SEPP may be a security edge protection proxy connecting the serving wireless network and the home wireless network. The SEPP may handle WN-with-WN communication. The SEPP in 6GS may have a different name or embedded in a new 6G NF. A NEF/SEPP, in a cross-domain concept, both scenarios are accounted for, and NEF and SEPP are collectively referred to as NEF/SEPP.

During step 1005, as part of WTRU registration, the network (e.g., AMF, iTMF, other NFs, AF, and/or AS) may provision the WTRU with one or more parameters (e.g. the WTRU may receive provision information). The WTRU may be provisioned with a list of trusted eTMFs, which may be eTMFs trusted by the iTMF. For example, there may be a business relationship that has been established between the internal domain and the external domain. In another example, trust collaboration may have been established between the iTMF and the eTMFs. In another example, the iTMF may have been configured with the trustable eTMFs. In another example, the eTMFs may have been indicated to the iTMF by other WTRUs. The iTMF has verified the eTMFs and may know that they may be used for the requestor WTRU. The WTRU may be provisioned (e.g., by AF/AS) with inbound-enabled services for each eTMF. For each trusted eTMF, the network may specify a subset of inbound-enabled ServiceIDs. Inbound-enabled services are the service that may be enabled by using the TINFO pulled by the WTRU from eTMFs.

The WTRU may request its TINFO from an eTMF, by sending an inbound trust information request message 1010. The inbound trust information request message may be sent to an eTMF selected from the list of trusted TMFs provided during provisioning. The inbound trust information request message, sent from the WTRU to the eTMF may include one or more of the following parameters. The inbound trust information request message may include an iTMF ID (iTMFID), which may be the identifier for iTMF. The inbound trust information request message may include a WTRU ID (WTRUID), which may be the WTRU's identifier, which may be recognized by the iTMF. The inbound trust information request message may include a WTRU external ID (WTRUExternalID), which may be the WTRU's external domain identifier, which may be recognized by the eTMF. The inbound trust information request message may include a WTRU credential (WTRUCredential), which may be a credential of the WTRU, which may be used by eTMF to verify legitimacy of the WTRU. The inbound trust information request message may include a NFP ID (NFPID), which may be the NFP's identifier that may be recognized by the eTMF. Since the WTRU aims to access services from the NFP in step 1030, it is assumed that the WTRU knows the NFP or has discovered the NFP before step 1010 or as a part of step 1005. The inbound trust information request message may include a NFP external ID (NFPExternalID). The NFP's identifier may be recognized by the eTMF. The presence of NFPExternalID is optional. If the NFP is a traditional CN NF, it may not have an external ID. However, an external ID may exist if the NFP is embedded on or in a WTRU, which is a plausible scenario in 6G. The inbound trust information request message may include a service ID (ServiceID), which may be acquired during the initial provision, which may be recognized by iTMF. The eTMF cannot recognize or understand its meaning, but may be aware of its corresponding TINFO with ExternalServiceID-TINFO. The WTRU may also request a service type outside the initial provision, in that case, ServiceID, which is likely to be declined. The inbound trust information request message may include an inbound request ID (InboundRequestID), which may be a unique randomly generated identifier used by the NFP to match the upcoming NFP access request from the WTRU with the TINF from the WTRU. The inbound trust information request message may include a final TIDX required (FinalTIDXRequried), which may be a Boolean value that indicates whether the WTRU is requesting the final TIDX value from the eTMF. If the Boolean value indicates True, the eTMF may request the necessary TINFO from the iTMF, and calculate the final TIDX locally, and returns it to the WTRU. If the Boolean value indicates False, the eTMF may provide the TINFO based on the ExternalServiceID-TINFO and return it directly to the WTRU.

Upon receiving the inbound trust information request message, the eTMF may perform inbound trust negotiation 1015 and may identify the WTRU with WTRUExternalID and authenticate the WTRU with WTRUCredential. This step may be needed for two scenarios. The step may be applied for a not recognizable ServiceID scenario. If the ServiceID is not recognizable by the eTMF, the eTMF may reach out to the iTMF for inbound trust negotiation, detailed in ExternalServiceID-TINFO mapping. The step may be applied for a require final TIDX scenario. If FinalTIDXRequried is True in step 1010, the eTMF may need to request the iTMF to provide the TINFO of the WTRU to the eTMF. This allows the eTMF to combine the TINFO from itself and the TINFO provided by the iTMF. Using this combined information, the eTMF may determine final TIDX for the WTRU.

The eTMF may send an inbound trust information response message 1020. The inbound trust information response message may be sent directly to the WTRU. The inbound trust information response message may include the WTRUTINFO required for the WTRU to prove its trustworthiness to the NFP. The WTRUTINFO may be in one of two forms, each with a distinct structure and signature.

The WTRUTINFO may be in a WTRUTIDX form. The trust index may have been fully calculated in step 1015, which can be used by the NFP to make an immediate access decision. There may be additional parameters wrapped or included in the inbound trust information response message along with the WTRUTIDX. An additional parameter may include an iTMF ID (iTMFID). The iTMFID may be the identifier of iTMF. An additional parameter may include an iTMF credential (iTMFCredential), which may be used by the NFP to verify that the trust index result has been approved by the iTMF. The iTMF may have shared the credential along with the TINFO to the eTMF in step 1015. An additional parameter may include an eTMF signature (eTMFSignature), which may be a self-contained signature of the eTMF that guarantees the authenticity and integrity of the WTRUTIDX. The signature may include one or more of the following fields. The eTMFSignature may include an iTMF signature (iTMFsignature), which may state or indicate that the eTMF will encapsulate this signature showing to the NFP that the TINFO is approved by the iTMF and may include a wrapper: eTMFID and InboundRequestID: same as InboundRequestID in step 1010. The eTMFSignature may include an audience, which may be the identifier of the intended recipient, which is the NFPID. The eTMFSignature may include a trust scope, which may be the ServiceID associated with this TIDX. The eTMFSignature may include a requestor, which may be the identifier of the WTRU (WTRUID) requesting the TIDX. The eTMFSignature may include a subject, which may be the identifier of the WTRU (WTRUID). The eTMFSignature may include an interactor, which may be the identifier of the NFP (NFPID, NFPExternalID). The interactor may be interacting with the subject and influencing the subject's TIDX. The eTMFSignature may include a trust issuer, which may be the identifier of the eTMF (ExternalTMFID) and the identifier of iTMF (iTMFID), indicating the source of the TIDX. The eTMFSignature may include an InboundRequestID, which may be the same as the InboundRequestID in step 1010.

The WTRUTINFO may be in a WTRUTIDC form. The eTMF may send only the mapped TIDC to the WTRU. The iTMF can then use the TIDC to compute the final TIDX (e.g., in step 1035). There may be additional parameters wrapped or included in the inbound trust information response message along with the WTRUTIDC. An additional parameter may include an eTMFID, which may be the identifier of the eTMF. An additional parameter may include an eTMFCredential, which may be used by the iTMF to verify that the trust indicators originate from the eTMF. An additional parameter may include ab eTMFSignature, which may be a self-contained signature of the eTMF to ensure the integrity and authenticity of the WTRUTIDC. The following fields may be included in the signature: Audience: the identifier of the intended recipient, which in this case is the iTMFID; Requestor: the identifier of the WTRU (WTRUID) requesting the trust indicators; Subject: the identifier of the WTRU (WTRUID); Interactor: the identifier of the NFP (NFPID), where the interactor may interacting with the subject and influencing the subject's TIDX; Trust scope: the ServiceID associated with the requested trust indicators; Trust issuer: the identifier of the eTMF (ExternalTMFID), indicating the source of the trust indicators; InboundRequestID: same as InboundRequestID in step 1010.

The WTRU may sends a NF access request message 1025 to the NFP with the recently collected WTRUTINFO. The NF access request message may include one or more of the following parameters: WTRUID: WTRU's 3GPP identifier (e.g., SUCI) that may be recognized by the NFP; WTRUCredential: WTRU's credential that the NFP will use to authenticate the NF access request; ServiceID: same as ServiceID in step 1010; WTRUTINFO: as received from step 1020; InboundRequestID: same as InboundRequestID in step 1010.

The NFP may receive the NF access request message from the WTRU. After identifying the WTRU with WTRUID and authenticating the WTRU with WTRUCredential, the NFP may begin to inspect the WTRUTINFO. If the WTRUTINFO is a WTRUTIDX, the NFP may immediately verify the WTRUTIDX using the iTMFID and iTMFCredential, confirming the WTRUTINDX is approved by the iTMF by matching the InboundRequestID in the request and InboundRequestID in the signature. Based on the WTRUTINDX, the NFP may then determine whether to grant or deny access, skipping steps 1030-1040 and proceeding to step 1045. This approach allows for faster decision-making since the TIDX of the WTRU has already been contained or included in WTRUTINFO. If the WTRUTINFO is a WTRUTIDC, the NFP may forward the WTRUTIDC to the iTMF in a trust index request message 1030 for further processing and to compute the final TIDX. InboundRequestID may be also passed to the iTMF.

By supporting both WTRUTIDX and WTRUTIDC, the system provides flexibility in how trust information may be exchanged and processed. WTRUTIDX allows for faster, more streamlined access decisions, while WTRUTIDC offers more comprehensive and detailed evaluations.

If the WTRUTINFO is still incomplete as being WTRUTIDC, the NFP may send a trust index request to the iTMF, including the WTRUTINFO and InboundRequestID provided by the WTRU. This additional WTRUTINFO helps the iTMF to make a more comprehensive and accurate trust assessment.

The iTMF may receive the WTRUTINFO in the trust index request message 1030 and may identify any previously cached WTRUTINFO associated with the eTMFID, eTMFCredential, and InboundRequestID. The iTMF may then perform trust evaluation 1035, which is the same as step 855 of FIG. 8, to determine the final trust index (TIDX) for the WTRU.

The iTMF may send a trust index response message 1040 to the NPF, which is the same as step 945 of FIG. 9. The NFP may send a NF access response message 1045, which is the same as step 950 of FIG. 9.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by a wireless transmit/receive unit (WTRU), the method comprising:
receiving trust management function (TMF) configuration information that comprises at least one identifier of at least one external TMF (eTMF), wherein the at least one eTMF is a TMF that operates in a different network domain as the WTRU;
sending a first request message to a first network node, wherein the first request message comprises a first service identification (service ID) that indicates a requested service;
receiving a second request message from a second network node, wherein the second request message comprises an identifier of the second network node, and a second service ID;
determining that the identifier of the second network node in the second request message matches an identifier from the at least one identifier of the at least one eTMF in the TMF configuration information;
determining that the second service ID in the second request message matches the first service ID in the first request message;
sending a first response message to the second network node that indicates permission for the second network node to expose WTRU trust information to a third network node; and
receiving a second response message from the first network node that indicates whether the requested service is granted.

2. The method of claim 1, wherein the first request message is a network function (NF) access request message, and wherein the first network node is a network function producer (NFP).

3. The method of claim 1, wherein the TMF configuration information further comprises an identifier of an internal TMF (iTMF), wherein the iTMF is a TMF that operates in a same network domain as the WTRU.

4. The method of claim 1, wherein the first request message is sent using non-access stratum (NAS) signaling or a service-based interface (SBI).

5. The method of claim 1, wherein the first request message comprises at least one of: an internal WTRU identifier for a domain that the WTRU is operating in, an external WTRU identifier for a domain that the WTRU is not operating in, a WTRU credential, a WTRU context, an indication of a set of mapping pairs between the at least one identifier of the at least one eTMF and the external WTRU ID, an indication of a WTRU hardware parameter, or an indication of a WTRU power source.

6. The method of claim 1, wherein the second request message is a trust exposure request message that is a request for permission to share the WTRU's trust information with an internal TMF (iTMF), wherein the iTMF is a TMF that operates in a same network domain as the WTRU, and wherein the second request message comprises an identifier of the third network node.

7. The method of claim 6, further comprising determining that the identifier of the third network node in the second request message matches an identifier of an iTMF received in the TMF configuration information.

8. The method of claim 1, wherein the second network node is an eTMF from the at least one eTMF and the third network node is an internal TMF (iTMF).

9. The method of claim 1, wherein the first response message comprises at least one of: an indication of a number of external trust information requests that the second network node is allowed to expose the WTRU trust information; an indication of a time period for which WTRU trust permission is valid; or a list of iTMFs which the WTRU approves the eTMF to expose WTRU trust information without WTRU permission.

10. The method of claim 1, wherein the second response message comprises a failed reason in response to the requested service being denied.

11. A wireless transmit/receive unit (WTRU) comprising:
a transmitter;
a receiver; and
a processor, wherein:
the receiver is configured to receive trust management function (TMF) configuration information that comprises at least one identifier of at least one external TMF (eTMF), wherein the at least one eTMF is a TMF that operates in a different network domain as the WTRU;
the transmitter is configured to send a first request message to a first network node, wherein the first request message comprises a first service identification (service ID) that indicates a requested service;
the receiver is further configured to receive a second request message from a second network node, wherein the second request message comprises an identifier of the second network node, and a second service ID;
the processor is configured to determine that the identifier of the second network node in the second request message matches an identifier from the at least one identifier of the at least one eTMF in the TMF configuration information;
the processor is further configured to determine that the second service ID in the second request message matches the first service ID in the first request message;
the transmitter is further configured to send a first response message to the second network node that indicates permission for the second network node to expose WTRU trust information to a third network node; and
the receiver is further configured to receive a second response message from the first network node that indicates whether the requested service is granted.

12. The WTRU of claim 11, wherein the first request message is a network function (NF) access request message, and wherein the first network node is a network function producer (NFP).

13. The WTRU of claim 11, wherein the TMF configuration information further comprises an identifier of an internal TMF (iTMF), wherein the iTMF is a TMF that operates in a same network domain as the WTRU.

14. The WTRU of claim 11, wherein the first request message is sent using non-access stratum (NAS) signaling or a service-based interface (SBI).

15. The WTRU of claim 11, wherein the first request message comprises at least one of: an internal WTRU identifier for a domain that the WTRU is operating in, an external WTRU identifier for a domain that the WTRU is not operating in, a WTRU credential, a WTRU context, an indication of a set of mapping pairs between the at least one identifier of the at least one eTMF and the external WTRU ID, an indication of a WTRU hardware parameter, or an indication of a WTRU power source.

16. The WTRU of claim 11, wherein the second request message is a trust exposure request message that is a request for permission to share the WTRU's trust information with an internal TMF (iTMF), wherein the iTMF is a TMF that operates in a same domain as the WTRU, and wherein the second request message comprises an identifier of the third network node.

17. The WTRU of claim 16, wherein the processor is further configured to:
determine that the identifier of the third network node in the second request message matches an identifier of an iTMF received in the TMF configuration information.

18. The WTRU of claim 11, wherein the second network node is an eTMF from the at least one eTMF and wherein the third network node is an internal TMF (iTMF).

19. The WTRU of claim 11, wherein the first response message comprises at least one of: an indication of a number of external trust information requests that the second network node is allowed to expose the WTRU trust information; an indication of a time period for which WTRU trust permission is valid; or a list of iTMFs which the WTRU approves the eTMF to expose WTRU trust information without WTRU permission.

20. The WTRU of claim 11, wherein the second response message comprises a failed reason in response to the requested service being denied.
